(19) United States
(12) Patent Application Publication
(10) Pub. No.: US 2019/0092289 A1
(43) Pub. Date: Mar. 28, 2019

(54) REARWARD MOVEMENT PREVENTING DEVICE OF PEDAL DEVICE FOR VEHICLE

(71) Applicant: TOYODA IRON WORKS CO., LTD., Toyota-shi (JP)

(72) Inventors: Junya ABE, Toyota-shi (JP); Kazuki OTANI, Toyota-shi (JP)

(73) Assignee: TOYODA IRON WORKS CO., LTD., Toyota-shi (JP)

(21) Appl. No.: 16/204,522

(22) Filed: Nov. 29, 2018

Related U.S. Application Data
(63) Continuation of application No. PCT/JP2016/089050, filed on Dec. 28, 2016.

(30) Foreign Application Priority Data
May 30, 2016 (JP) 2016-106941

(51) Int. Cl. B60T 7/06; G05G 1/327; G05G 5/06; B60R 21/09

(52) U.S. Cl. CPC B60T 7/065; G05G 1/327; G05G 2505/00; B60R 21/09; G05G 5/06

(57) ABSTRACT

A brake pedal device 1 includes a pedal bracket 10, an operating pedal 20, an intermediate lever 25, a coupling link 30, and a cylindrical member 40. A side plate 11 of the pedal bracket 10 includes an opening for preventing rearward movement 16 and a movement allowing part 17. The opening for preventing rearward movement 16 is located in a separating direction D relative to a second shaft hole 15. The movement allowing part 17 is configured to include a holding protrusion 18 and a cutout 19. When a load caused by a vehicle collision acts, a second support shaft 13 for supporting the intermediate lever 25 moves from the second shaft hole 15 toward the opening for preventing rearward movement 16 through the movement allowing part 17, forcibly causing the operating pedal 20 to pivot toward the vehicle front side about a first support shaft 12.

### CROSS-REFERENCE TO RELATED APPLICATION

This application is based upon and claims the benefit of priority of the prior Japanese Patent Application No. 2016-106941, filed on May 30, 2016, the entire contents of which are incorporated herein by reference.

### FIELD

The present disclosure relates to a rearward movement preventing device of a pedal device for vehicle which prevents an operation pedal from moving rearward when a dash panel is displaced toward a vehicle rear side accompanying with the vehicle collision.

### BACKGROUND

Conventionally, for example, a disclosure disclosed in Japanese Laid-open Patent Publication No. 2008-204096 is known as a rearward movement preventing device of a pedal device for vehicle which prevents an operation pedal from moving to an occupant side on the rear side of a vehicle body at the time of vehicle collision. Disclosures disclosed in the Japanese Laid-open Patent Publication No. 2008-204096 relate to a pedal device for vehicle including a pedal bracket, a brake pedal, an intermediate lever, and a coupling link, and the disclosures are configured to prevent a depressing part of the operation pedal from moving rearward toward the driver's seat side when a dash panel is displaced rearward toward the driver's seat side.

Specifically, a pedal supporting structure for vehicle disclosed in the Japanese Laid-open Patent Publication No. 2008-204096 includes a pedal bracket arranged to a dash panel, a brake pedal pivotally supported around a first supporting shaft of the pedal bracket and including a depressing part used for depressing operation toward a vehicle front side at a lower end part, and a first link (corresponding to an intermediate lever of the present disclosure) pivotally supported around a second supporting shaft of the pedal bracket and connected to the brake pedal via a second link serving as a coupling link, the first link mechanically pivoting toward the output direction in conjunction with the brake pedal to displace a pushrod protruding from the dash panel toward the vehicle front side. Then, a sub pedal bracket constituting a rear part of the pedal bracket is fixed to an instrument panel reinforcement.

Then, when the dash panel and the instrument panel reinforcement are displaced rearward at the time of vehicle collision, the sub pedal bracket is bent so as to protrude toward the vehicle front side based on differences of each rearward displacement amount. At this time, a pedal bracket support constituting an intermediate part of the pedal bracket pivots around the second supporting shaft with respect to a main pedal bracket. Due to an abutment with the sub pedal bracket, the first link corresponding to the intermediate lever pivots around the first supporting shaft to displace the pushrod toward the output direction (to the vehicle front side). Thus, since the brake pedal pivots toward the vehicle front side via the second link, in the pedal supporting structure for vehicle disclosed in the Patent Document 1, the depressing part of the brake pedal is prevented from moving rearward toward the driver's side when the dash panel is displaced rearward toward the driver's seat side.

### SUMMARY

According to an aspect of the embodiments, a rearward movement preventing device of a pedal device for vehicle, the pedal device for vehicle includes: a pedal bracket configured to fix to a dash panel on a vehicle front side and include a pair of side plates arranged with a gap in a vehicle width direction; an operation pedal configured to pivotally support by a first support shaft arranged in the pair of side plates of the pedal bracket and include a depressing part used for depressing operation toward the vehicle front side; an intermediate lever configured to pivotally support around a second support shaft arranged in parallel with the first support shaft with respect to the pedal bracket, the intermediate lever pivots around the second support shaft toward an output direction to displace a prescribed output member toward the vehicle front side; and a coupling link configured to connect the operation pedal to the intermediate lever and pivot the intermediate lever toward the output direction in conjunction with the depressing operation of the operation pedal; wherein the rearward movement preventing device prevents the depressing part of the operation pedal from displacing toward a vehicle rear side when the dash panel is displaced toward the vehicle rear side, and wherein the pair of side plate of the pedal bracket includes: an opening for preventing rearward movement configured to be in a direction of a load acting on the second support shaft at a time of vehicle collision with respect to a shaft hole of the second support shaft; and a movement allowing part configured to hold the second support shaft into the shaft hole of the second support shaft and allow movement of the second support shaft toward the opening for preventing rearward movement when the load due to the vehicle collision acts.

The object and advantages of the invention will be realized and attained by means of the elements and combinations particularly pointed out in the claims.

It is to be understood that both the forgoing general description and the following detailed description are exemplary and explanatory and are not restrictive of the invention.

### BRIEF DESCRIPTION OF DRAWINGS

FIG. 1 is a side view illustrating a schematic configuration of a brake pedal device according to the first embodiment;

FIG. 2 is a side view illustrating movement of the brake pedal device according to the first embodiment in a depressing operation;

FIG. 3 is an explanatory view illustrating a relationship between a load acting in the depressing operation of the brake pedal device according to the first embodiment and a separating direction;

FIG. 4 is an enlarged view illustrating a configuration in a vicinity of a second shaft hole of the brake pedal device according to the first embodiment;

FIG. 5 is a cross-sectional view taken along line A-A of FIG. 1;

FIG. 6 is an explanatory view illustrating movement of the brake pedal device according to the first embodiment at a front collision;

FIG. 7 is a side view illustrating a schematic configuration of a brake pedal device according to the second embodiment;

FIG. 8 is a side view illustrating movement of the brake pedal device according to the second embodiment in a depressing operation;

FIG. 9 is an explanatory view illustrating a relationship between a load acting in the depressing operation of the brake pedal device according to the second embodiment and a separating direction;

FIG. 10 is an enlarged view illustrating a configuration in a vicinity of a second shaft hole of the brake pedal device according to the second embodiment;

FIG. 11 is an explanatory view illustrating movement of the brake pedal device according to the second embodiment at a front collision;

FIG. 12 is an explanatory view illustrating movement of a brake pedal device according to the third embodiment at a front collision;

FIG. 13 is an enlarged view illustrating a configuration in a vicinity of a second shaft hole of the brake pedal device according to the third embodiment;

FIG. 14 is an explanatory view illustrating movement of a brake pedal device according to the fourth embodiment at a front collision; and

FIG. 15 is an enlarged view illustrating a configuration in a vicinity of a second shaft hole of the brake pedal device according to the fourth embodiment.

### DESCRIPTION OF EMBODIMENTS

Here, in the rearward movement preventing device of the pedal device for vehicle including the pedal supporting structure for vehicle disclosed in the Japanese Laid-open Patent Publication No. 2008-204096, it is assumed that the intermediate lever pivots toward the output direction while pressing the pushrod serving as an output member toward a brake booster on the vehicle front side. However, output members such as the pushrod often are not able to be pushed toward the vehicle front side due to a deformation of each part at the time of vehicle collision and an influence of medium pressure in the brake booster.

Accordingly, in the rearward movement preventing device of the pedal device for vehicle disclosed in the Japanese Laid-open Patent Publication No. 2008-204096, a situation where the output member is not able to be pushed toward the vehicle front side can cause a case that the intermediate lever is not able to be pivoted toward the output direction, thereby not performing a rearward movement preventing function to prevent the depressing part from moving rearward by pivoting the brake pedal toward the depressing direction.

The present disclosure relates to a rearward movement preventing device of a pedal device for vehicle which prevents an operation pedal from moving rearward when a dash panel is displaced toward a vehicle rear side accompanying with a vehicle front collision, and provides a rearward movement preventing device of a pedal device for vehicle capable of performing a rearward movement preventing function of an operation pedal even in a state where output members are not able to be displaced toward a vehicle front side.

### First Embodiment

An embodiment (first embodiment) applying a rearward movement preventing device of a pedal device for vehicle according to the present disclosure to a brake pedal device 1 for a service brake will be hereinafter described in detail with reference to the drawings.

(Schematic Configuration of a Brake Pedal Device)

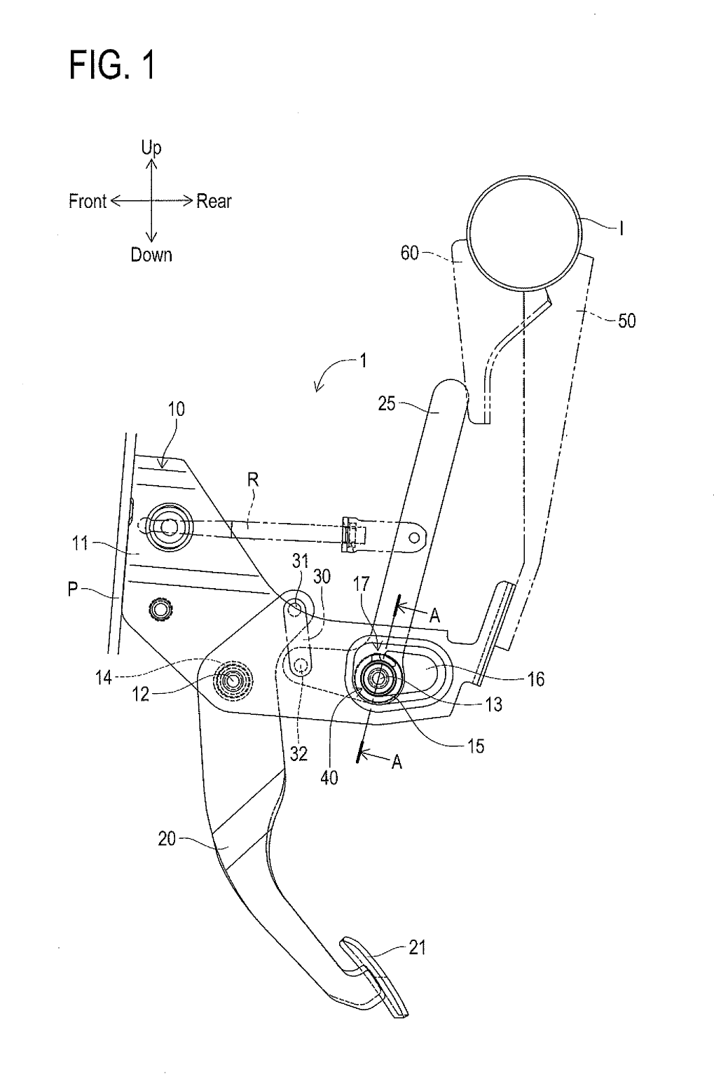

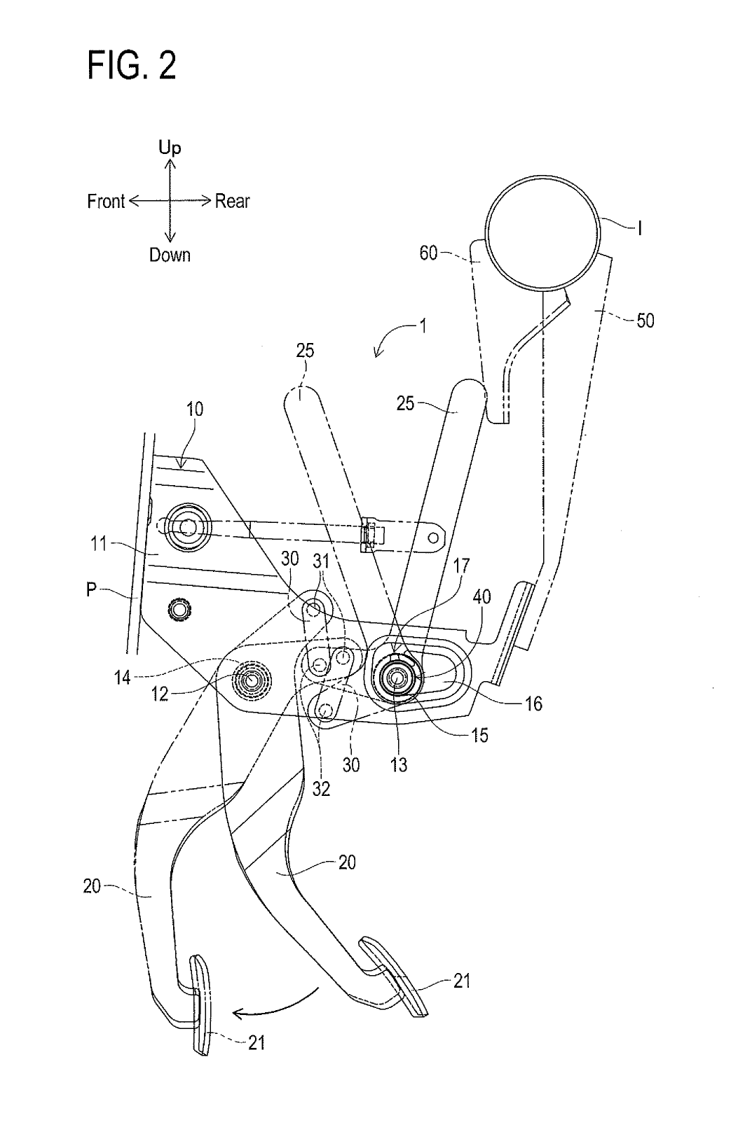

First, a schematic configuration of the brake pedal device 1 according to the first embodiment will be described in detail with reference to FIGS. 1 and 2.

The brake pedal device 1 according to the first embodiment is securely arranged with respect to a dash panel P that partitions an engine room and a vehicle compartment and a vehicle body member (for example, an instrument panel reinforcement I etc.) arranged on a vehicle rear side relative to the dash panel P (driver's seat side), and includes a pedal bracket 10, an operation pedal 20, an intermediate lever 25, a coupling link 30, and a cylindrical member 40. Then, the brake pedal device 1 is configured to displace an operating rod R of a brake booster toward a vehicle front side when the operation pedal 20 is pivoted by a depressing operation of the operation pedal 20, thereby generating a braking force with respect to a vehicle.

The brake booster is integrally fixed to a vehicle front side (i.e. engine room side) of the dash panel P and includes the operating rod R serving as an output member. When the operating rod R is displaced toward the vehicle front side, the brake booster doubles the braking force transmitted through the operation pedal 20 and transmits the doubled braking force to the vehicle. Then, the operating rod R is arranged to project out into the vehicle compartment on the vehicle rear side from the dash panel P and is configured to be displaceable toward a vehicle front and back direction.

As illustrated in FIG. 1, the instrument panel reinforcement I is arranged on the vehicle rear side (driver's seat side) relative to the dash panel P and configures the vehicle body member in the present disclosure. In the instrument panel reinforcement I, the possibility of being displaced toward the vehicle rear side and a deformation amount when a large load is input from the vehicle front side such as at a time of collision are generally smaller than the dash panel P.

Then, the instrument panel reinforcement I is integrally fixed to a fastening bracket 50 and a bracket for collision 60. The fastening bracket 50 and the instrument panel reinforcement I form the vehicle body member in the present disclosure. The fastening bracket 50 is fixed to extend out downwardly from the instrument panel reinforcement I, and a vehicle rear end part of the pedal bracket 10 is fastened and fixed with a bolt and a nut.

The bracket for collision 60 and the instrument panel reinforcement I form the vehicle body member in the present disclosure. The bracket for collision 60 is located on the vehicle rear side relative to an upper part of the intermediate lever 25 supported by a second support shaft 13 and abuts on the upper part of the intermediate lever 25 when a large load is input such as at the time of front vehicle collision.

The pedal bracket 10 is secured to a vehicle compartment side of the dash panel P at a vehicle front side part using a bolt etc. The pedal bracket 10 is fastened and fixed with respect to the fastening bracket 50 fixed to the instrument panel reinforcement I at a vehicle rear side part with a bolt and a nut. Then, the pedal bracket 10 includes a pair of side plates 11 that face with each other with a gap in a vehicle width direction. The pedal bracket 10 is arranged with a first support shaft 12 and the second support shaft 13. Then, a first shaft hole 14, a second shaft hole 15, an opening for preventing rearward movement 16, and a movement allowing part 17 are formed in each of the side plate 11 of the pedal bracket 10.

The first support shaft 12 extends substantially horizontally and substantially parallel with the vehicle width direction between the pair of side plates 11 in the pedal bracket 10. The first support shaft 12 is arranged by inserting through the first shaft hole 14 formed in the side plate 11 of the pedal bracket 10. Specifically, the first support shaft 12 is fixed to the pedal bracket 10 by caulking in a state where the first support shaft 12 is inserted through the first shaft hole 14 in each of the side plate 11 of the pedal bracket 10.

Then, the second support shaft 13 according to the first embodiment is located on the vehicle rear side relative to the operation pedal 20. The second support shaft 13 is arranged by inserting through the second shaft hole 15 formed in the pedal bracket 10 to extend parallel to the first support shaft 12. Specifically, the second support shaft 13 is fixed to the pedal bracket 10 by caulking in a state where the second support shaft 13 is inserted through the cylindrical member 40 press fitted into the second shaft hole 15 in each of the side plate 11 of the pedal bracket 10.

The opening for preventing rearward movement 16 and the movement allowing part 17 are formed in a vicinity of the second shaft hole 15. The movement allowing part 17 performs a function of holding the second support shaft 13 arranged with the cylindrical member 40 into the second shaft hole 15 even when the depressing operation of the operation pedal 20 is performed and a function of allowing a movement of the second support shaft 13 and the cylindrical member 40 toward the opening for preventing rearward movement 16 when a load due to a vehicle collision and the like acts. Specific configurations of the opening for preventing rearward movement 16 and the movement allowing part 17 will be described in detail later with reference to the drawings.

The operation pedal 20 includes an upper part pivotally supported by the first support shaft 12 arranged in the pedal bracket 10 and includes a depressing part 21 at a lower end part. Accordingly, when the depressing operation is performed by the depressing part 21, the operation pedal 20 pivots around the first support shaft 12. In this case, the depressing part 21 moves toward the vehicle front side.

Then, the intermediate lever 25 includes a lower part pivotally supported by the second support shaft 13 arranged in the pedal bracket 10 and extends upwardly. In the first embodiment, the intermediate lever 25 is located on the vehicle rear side relative to the operation pedal 20. The operating rod R is coupled to an upper part of the intermediate lever 25 via a clevis. Accordingly, when the intermediate lever 25 pivots with the second support shaft 13 as a center, the operating rod R can be displaced toward the vehicle front and back direction. That is, according to the brake pedal device 1, a braking force can be generated through the brake booster by pressing the operating rod R toward the vehicle front side with the intermediate lever 25.

The coupling link 30 couples an upper rear side part of the operation pedal 20 to a lower front side part of the intermediate lever 25 and is pivotally attached to the operation pedal 20 and the intermediate lever 25. Since one end side of the coupling link 30 is coupled to the upper rear side part of the operation pedal 20 via a connection pin 31, the coupling link 30 can be pivoted with respect to the operation pedal 20 with the connection pin 31 as a center. And, since the other end side of the coupling link 30 is coupled to the lower front side part of the intermediate lever 25 via a connection pin 32, the coupling link 30 can be pivoted with respect to the intermediate lever 25 with the connection pin 32 as a center. Accordingly, in the brake pedal device 1, the pivoting of the operation pedal 20 with the first support shaft 12 as the center can be transmitted to the intermediate lever 25 via the coupling link 30, so that the intermediate lever 25 can be pivoted with the second support shaft 13 as the center.

The cylindrical member 40 is a member arranged into the second shaft hole 15 in a state where the cylindrical member 40 is inserted by the second support shaft 13 and includes a cylindrical part 41 and a flange part 42. As described above, the cylindrical member 40 is formed of a hard resin material. The cylindrical member 40 is inserted by the second support shaft 13 in a state where the cylindrical member 40 is press fitted into the second shaft hole 15. The cylindrical member 40 will be described in detail later with reference to the drawings.

(Movement of Each Unit Involved in Depressing Operation of the Operation Pedal)

Next, in the brake pedal device 1 described above, movement of each unit when the depressing operation of the operation pedal 20 is performed will be described.

As illustrated in FIG. 2, when the depressing operation of the operation pedal 20 is performed, the depressing part 21 is depressed toward the vehicle front side, and thus the operation pedal 20 pivots with the first support shaft 12 as the center. At this time, since the upper part of the operation pedal 20 pivots toward a predetermined direction (clockwise in FIGS. 1 and 2) with the first support shaft 12 as the center, the pivoting of the operation pedal 20 is transmitted to the intermediate lever 25 via the coupling link 30.

As described above, since the coupling link 30 is coupled to the lower front side part of the intermediate lever 25 via the connection pin 32, the intermediate lever 25 pivots with the second support shaft 13 as the center following the pivoting of the operation pedal 20, and the upper part of the intermediate lever 25 is moved toward the vehicle front side. At this time, a state is maintained where the second support shaft 13 and the cylindrical member 40 are held into the second shaft hole 15 by the movement allowing part 17. Further, since the operating rod R of the brake booster is coupled to the upper part of the intermediate lever 25 via the clevis, the brake pedal device 1 can push the operating rod R toward an output direction (vehicle front side) in conjunction with the depressing operation of the operation pedal 20, and thus can generate the braking force with respect to the vehicle.

(Force Acting on Each of the Unit of the Brake Pedal Device 1 According to the First Embodiment)

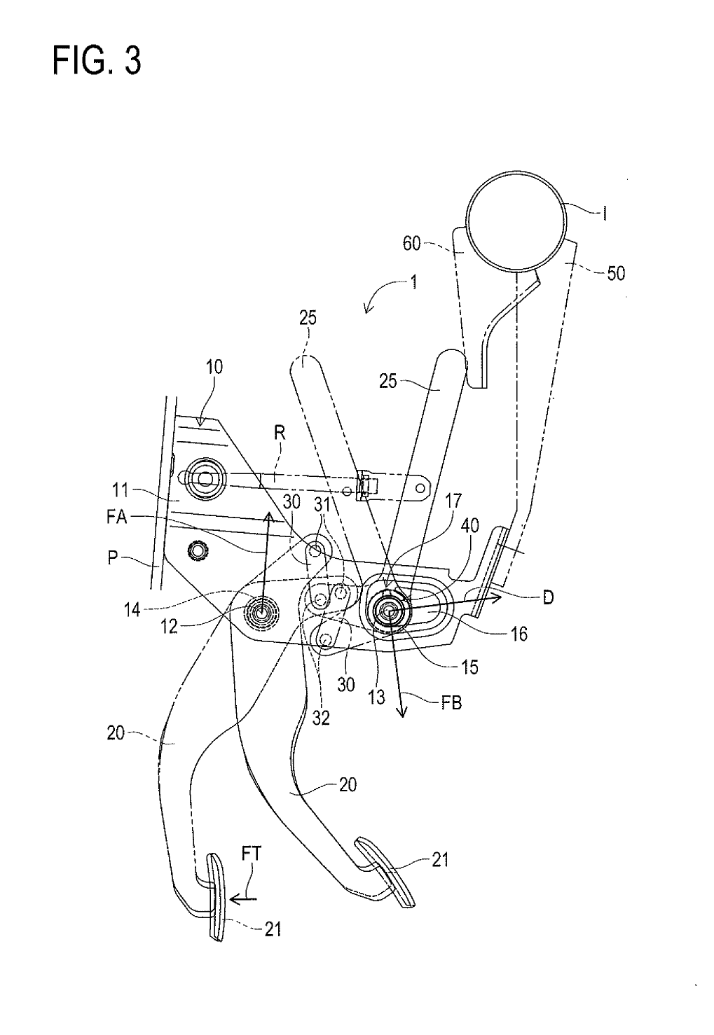

Subsequently, a force acting on each unit of the brake pedal device 1 in the depressing operation of the operation pedal 20 will be described with reference to FIG. 3. Incidentally, in the below description, a load acting on the depressing part 21 of the operation pedal 20 in the depressing operation of the operation pedal 20 is referred to as a road surface load FT.

As illustrated in FIG. 3, when the road surface load FT acts on the depressing part 21 of the operation pedal 20, and then the depressing operation is performed, the operation pedal 20 pivots with the first support shaft 12 as the center, and thus a load acts on the connection pin 31 of the coupling link 30. Accordingly, a load acting on the first support shaft 12 (hereinafter, referred to as a first load FA) in the depressing operation of the operation pedal 20 can be calculated by a resultant force of the road surface load FT and the load acting on the connection pin 31, and a magnitude and a direction of the first load FA can be specified.

Then, since the intermediate lever 25 is coupled to the operation pedal 20 via the coupling link 30, the intermediate lever 25 pivots with the second support shaft 13 as the center in conjunction with the depressing operation of the operation pedal 20. Accordingly, in the intermediate lever 25, a load acts on the connection pin 32 of the coupling link 30. The load acting on the connection pin 32 is a reaction force of the load input to the connection pin 31.

And, the intermediate lever 25 pivots with the second support shaft 13 as the center to displace the operating rod R of the brake booster toward the output direction. Accordingly, a reaction force of a load when the operating rod R is displaced toward the output direction is input to the upper part of the intermediate lever 25. Therefore, a load acting on the second support shaft 13 (hereinafter, referred to as a second load FB) due to the pivoting of the intermediate lever 25 in the depressing operation of the operation pedal 20 can be calculated by a resultant force of the load acting on the connection pin 32 and the load input to the intermediate lever 25 when the operating rod R is displaced, and a magnitude and a direction of the second load FB can be specified.

In the brake pedal device 1 according to the first embodiment, the opening for preventing rearward movement 16 and the movement allowing part 17 are formed according to the direction of the second load FB acting on the second support shaft 13 and a separating direction D determined by the second load FB with reference to the second shaft hole 15. The above will be described later with reference to the drawings.

(Configuration in the Vicinity of the Second Shaft Hole 15 of the Brake Pedal Device According to the First Embodiment)

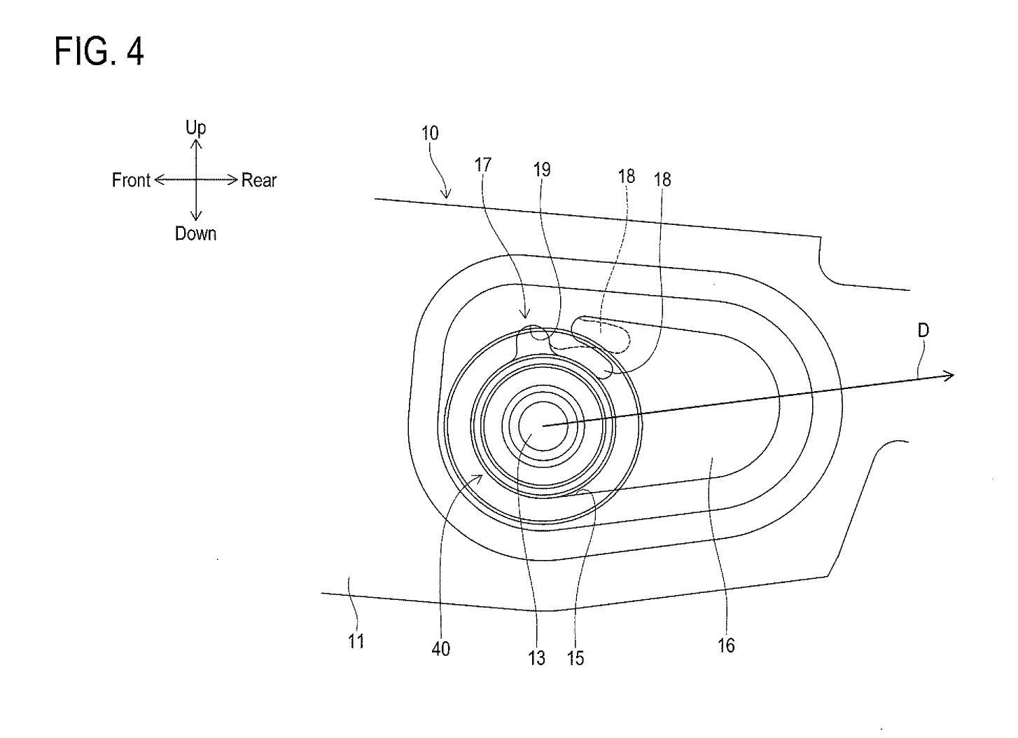

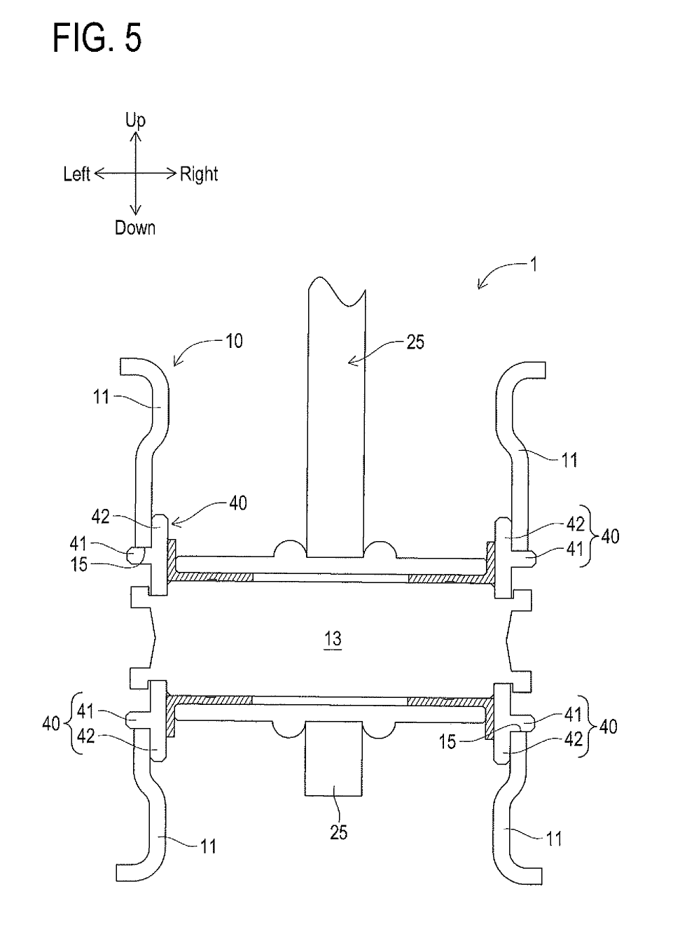

As described above, in the brake pedal device 1 according to the first embodiment, the opening for preventing rearward movement 16 and the movement allowing part 17 are formed in the vicinity of the second shaft hole 15. A configuration in the vicinity of the second shaft hole 15 according to the first embodiment will be described in detail with reference to FIGS. 4 and 5.

As illustrated in FIG. 4, the opening for preventing rearward movement 16 is formed on a downstream side in the separating direction D with respect to the second shaft hole 15 and is configured to be partly communicated with the second shaft hole 15. Here, the separating direction D is a direction substantially orthogonal to the second load FB acting on the second support shaft 13 in the depressing operation of the operation pedal 20 (see FIG. 3), and indicates a direction substantially equal to a direction of separating by the load acting on the second support shaft 13 when the dash panel P is displaced toward the vehicle rear side due to the vehicle collision.

That is, according to the brake pedal device 1, since the opening for preventing rearward movement 16 is located on the downstream side in the direction substantially orthogonal to the second load FB with respect to the second shaft hole 15, the second support shaft 13 and the cylindrical member 40 are not moved toward the opening for preventing rearward movement 16 in the depressing operation of the operation pedal 20. And, since the opening for preventing rearward movement 16 is located on the downstream side in the direction of the load acting on the second support shaft 13 when the dash panel P is displaced toward the vehicle rear side due to the vehicle collision, the second support shaft 13 and the cylindrical member 40 can be moved from the second shaft hole 15 toward the opening for preventing rearward movement 16 when the dash panel P is displaced toward the vehicle rear side.

Then, the movement allowing part 17 is formed between the second shaft hole 15 and the opening for preventing rearward movement 16 in the separating direction D and is configured to include a holding protrusion 18 and a cutout part 19. The movement allowing part 17 performs the function of holding the second support shaft 13 and the cylindrical member 40 into the second shaft hole 15 under normal conditions such as the depressing operation of the operation pedal 20. Then, when the load due to the vehicle collision acts, the movement allowing part 17 performs the function of allowing movement of the second support shaft 13 and the cylindrical member 40 from the second shaft hole 15 toward the opening for preventing rearward movement 16.

The holding protrusion 18 constituting the movement allowing part 17 is a protruding piece formed so as to protrude from an opening edge (i.e. opening edge on an upper side) opposite to a side where the second load FB acts on the opening edge of the second shaft hole 15 and abuts on the second support shaft 13 and the cylindrical member 40 held into the second shaft hole 15 from a side of separating direction D. Accordingly, the holding protrusion 18 performs the function of holding the second support shaft 13 and the cylindrical member 40 into the second shaft hole 15. And, since the holding protrusion 18 is formed so as to protrude from the opening edge (i.e. opening edge on the upper side) opposite to the side where the second load FB acts on the opening edge of the second shaft hole 15, the holding protrusion 18 can maintain the function of holding the second support shaft 13 etc. into the second shaft hole 15 without deformation due to the load (i.e. the second load FB) in the depressing operation of the operation pedal 20.

Then, the cutout part 19 constituting the movement allowing part 17 is configured by cutting out a base end of the holding protrusion 18 in the opening edge (i.e. opening edge on the upper side) opposite to the side where the second load FB acts on the opening edge of the second shaft hole 15. Since the cutout part 19 can decrease a cross sectional area at the base end of the holding protrusion 18, the holding protrusion 18 can be deformed largely with the cutout part 19 as a starting point by the second support shaft 13 and the cylindrical member 40 moving from the second shaft hole 15 toward the opening for preventing rearward movement 16. That is, according to the brake pedal device 1, since the holding protrusion 18 can be easily deformed by the cutout part 19, the movement of the second support shaft 13 and the cylindrical member 40 from the second shaft hole 15 toward the opening for preventing rearward movement 16 can be reliably allowed when the load due to the vehicle collision acts.

As described above, the cylindrical member 40 is inserted by the second support shaft 13 and press fitted into the second shaft hole 15. The cylindrical member 40 is formed of the hard resin material, and as illustrated in FIG. 5, includes the cylindrical part 41 and the flange part 42. The cylindrical part 41 is a part to be press fitted into the second shaft hole 15 and is brought into pressure contact with the opening edge of the second shaft hole 15 etc. Accordingly, the cylindrical part 41 is arranged between an outer periphery of the second support shaft 13 and the opening edge of the second shaft hole 15.

The flange part 42 is formed to extend from an outer peripheral surface of the cylindrical part 41 toward an outside in the radial direction and is arranged along the side plate 11 of the pedal bracket 10 when the cylindrical member 40 is press fitted into the second shaft hole 15. As illustrated in FIG. 5, the cylindrical member 40 is press fitted into the second shaft hole 15 from an inside of the pedal bracket 10, and the flange part 42 is arranged along an inner surface in the side plate 11 of the pedal bracket 10. When the second support shaft 13 etc. moves from the second shaft hole 15 toward the opening for preventing rearward movement 16 at the time of vehicle collision, the flange part 42 can be moved along the side plate 11 of the pedal bracket 10 regardless of the shape of the opening edge in a part moving from the second shaft hole 15 toward the opening for preventing rearward movement 16. Accordingly, the flange part 42 of the cylindrical member 40 functions as a guide when the second support shaft 13 etc. moves from the second shaft hole 15 toward the opening for preventing rearward movement 16.

(Movement of the Brake Pedal Device at the Time of Vehicle Collision)

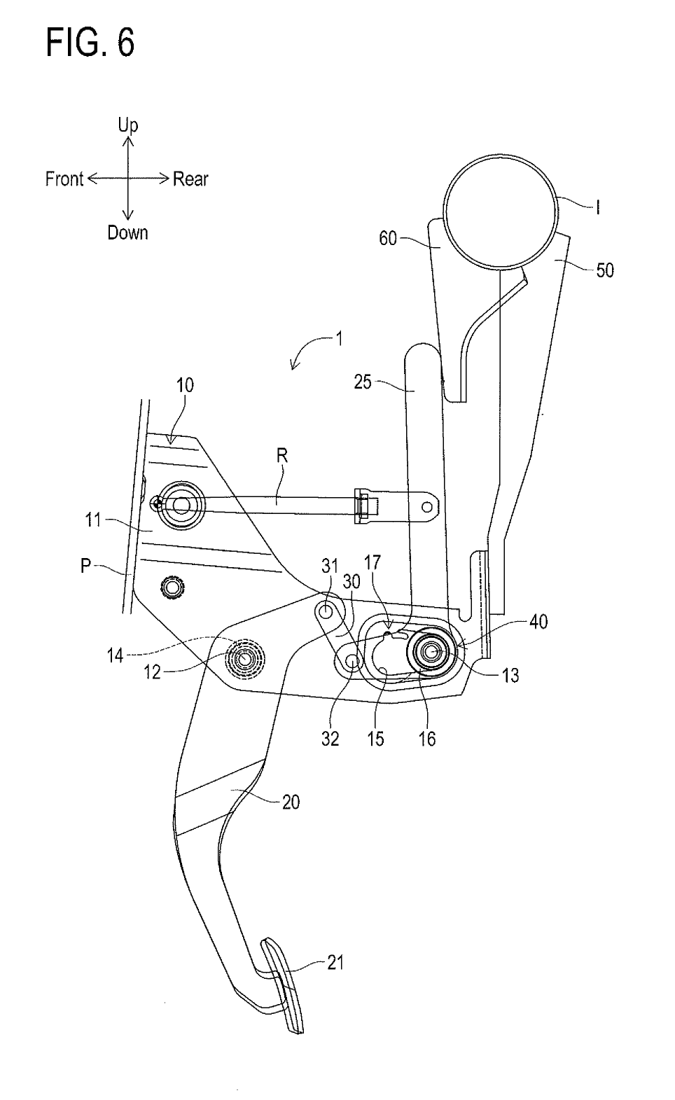

Next, the movement of the brake pedal device 1 at the time of vehicle collision will be described in detail with reference to FIG. 6. When the large load is input from the vehicle front side due to the vehicle collision etc., the dash panel P is displaced toward the vehicle rear side by the input large load. Meanwhile, even when the large load is input to the instrument panel reinforcement I from the vehicle front side, a displacement amount of the instrument panel reinforcement I toward the vehicle rear side is smaller than that of the dash panel P.

Then, a vehicle rear side part of the brake pedal device 1 is fastened and fixed with respect to the fastening bracket 50 fixed to the instrument panel reinforcement I, with a bolt and a nut. Accordingly, when the large load is input from the vehicle front side, and then the dash panel P is displaced toward the vehicle rear side, the brake pedal device 1 relatively moves toward the vehicle rear side as a whole while deforming a rear end part of the pedal bracket 10 (see FIGS. 1 and 6).

And, the bracket for collision 60 is fixed to the instrument panel reinforcement I and is arranged on the vehicle rear side relative to the upper part of the intermediate lever 25. Accordingly, when a whole of the brake pedal device 1 relatively moves toward the vehicle rear side following the displacement of the dash panel P toward the vehicle rear side, a load moving toward the vehicle front side is added to the upper part of the intermediate lever 25 by abutting on the bracket for collision 60.

Here, the operating rod R is coupled to the intermediate lever 25 via the clevis at a lower side relative to a position abutting on the bracket for collision 60. The operating rod R can be in a situation where the operating rod R is not able to be displaced toward the vehicle front side due to a deformation of each unit at the time of vehicle collision and an influence of medium pressure in the brake booster and the like. Thus, the intermediate lever 25 pivots with a coupling position (for example, clevis) with the operating rod R as a center, and then a lower end part of the intermediate lever 25 is moved toward the vehicle rear side.

Since the lower end part of the intermediate lever 25 is supported by the second support shaft 13, the load due to the vehicle collision acts on the second support shaft 13 toward the vehicle rear side. Thereby, the load due to the vehicle collision acts on the holding protrusion 18 through the second support shaft 13 and the cylindrical member 40 and deforms the holding protrusion 18 with the cutout part 19 as the starting point (see FIG. 4). As a result, the second support shaft 13 and the cylindrical member 40 move toward the separating direction D while deforming the holding protrusion 18 with the load due to the vehicle collision, moving from the second shaft hole 15 into the opening for preventing rearward movement 16 (see FIG. 6).

When the second support shaft 13 moves from the second shaft hole 15 toward the opening for preventing rearward movement 16 following the rearward displacement of the dash panel P, a distance between the first support shaft 12 and the second support shaft 13 becomes larger. The operation pedal 20 supported by the first support shaft 12 is coupled to the intermediate lever 25 supported by the second support shaft 13 via the coupling link 30. Accordingly, when the second support shaft 13 etc. move from the second shaft hole 15 toward the opening for preventing rearward movement 16, the operation pedal 20 is pulled by the coupling link 30, thereby forcibly pivoting around the first support shaft 12. As a result, according to the brake pedal device 1, even when the operating rod R is not able to be displaced toward the vehicle front side, the depressing part 21 of the operation pedal 20 can be prevented from moving rearward toward the driver's seat side by moving the second support shaft 13 from the second shaft hole 15 toward the opening for preventing rearward movement 16 accompanying with the front vehicle collision.

As explained above, the brake pedal device 1 according to the first embodiment includes the pedal bracket 10, the operation pedal 20, the intermediate lever 25, and coupling link 30, and can pivot the intermediate lever 25 via the coupling link 30 in conjunction with the pivoting of the operation pedal 20 following the depressing operation, thereby displacing the operating rod R of the brake booster toward the vehicle front side.

In the brake pedal device 1, each of the side plate 11 of the pedal bracket 10 includes the opening for preventing rearward movement 16 and the movement allowing part 17, and the opening for preventing rearward movement 16 is configured to be in the separating direction D that is a direction of the load acting on the second support shaft 13 at the time of vehicle collision with respect to the second shaft hole 15. Then, the movement allowing part 17 holds the second support shaft 13 into the second shaft hole 15 and allows the movement of the second support shaft 13 toward the opening for preventing rearward movement 16 when the load at the time of vehicle collision acts. Accordingly, according to the brake pedal device 1, when the load at the time of vehicle collision acts, the second support shaft 13 supporting the intermediate lever 25 can be moved from the second shaft hole 15 toward the opening for preventing rearward movement 16 through the movement allowing part 17.

Here, since the intermediate lever 25 is coupled to the operation pedal 20 via the coupling link 30, the operation pedal 20 forcibly pivots around the first support shaft 12 following the movement of the second support shaft 13 toward the opening for preventing rearward movement 16 through the movement allowing part 17. That is, according to the brake pedal device 1, the depressing part 21 of the operation pedal 20 can be forcibly pivoted without displacing the operating rod R toward the front side by moving the second support shaft 13 toward the opening for preventing rearward movement 16 through the movement allowing part 17 with the load at the time of vehicle collision.

And, in the brake pedal device 1, since the movement allowing part 17 performs the function of holding the second support shaft 13 into the second shaft hole 15, the second support shaft 13 does not move toward the opening for preventing rearward movement 16 in the depressing operation of the operation pedal 20. That is, according to the brake pedal device 1, the depressing operation of the operation pedal 20 can be reliably performed without moving the second support shaft 13.

In the brake pedal device 1, the movement allowing part 17 includes the holding protrusion 18 and the cutout part 19. The holding protrusion 18 is configured to protrude from the opening edge of the second shaft hole 15 on the side opposite to the side where the load (i.e. the second load FB) acts on the second support shaft 13 in the depressing operation of the operation pedal 20. Accordingly, the second support shaft 13 can be held into the second shaft hole 15 without deforming the holding protrusion 18 due to the load of the depressing operation when the depressing operation of the operation pedal 20 is performed.

Then, since the cutout part 19 is configured to form on the base end of the holding protrusion 18, the holding protrusion 18 is reliably deformed with the cutout part 19 as the starting point when the load in a direction different from the depressing operation (i.e. the load at the time of vehicle collision) acts. The second support shaft 13 can move from the second shaft hole 15 toward the opening for preventing rearward movement 16 due to the deformation the holding protrusion 18 with the cutout part 19 as the starting point. That is, according to the brake pedal device 1, the second support shaft 13 can be reliably moved toward the opening for preventing rearward movement 16, when the load due to the vehicle collision acts. That is, according to the brake pedal device 1, the depressing part 21 of the operation pedal 20 can be prevented from displacing toward the vehicle rear side without displacing the operating rod R toward the vehicle front side.

The brake pedal device 1 includes the cylindrical member 40, and the cylindrical member 40 is inserted by the second support shaft 13 and arranged to the second shaft hole 15. And, the cylindrical member 40 includes the cylindrical part 41 and the flange part 42. The cylindrical part 41 is arranged between the outer periphery of the second support shaft 13 and the opening edge of the second shaft hole 15. The flange part 42 extends from the cylindrical part 41 toward the outside in the radial direction and is arranged along the side plate 11 and the flange part 42 moves along the side plate 11 of the pedal bracket 10 when the second support shaft 13 moves toward the opening for preventing rearward movement 16 accompanying with the vehicle collision. That is, according to the brake pedal device 1, the second support shaft 13 can be smoothly and reliably moved toward the opening for preventing rearward movement 16 by the cylindrical member 40 accompanying with the vehicle collision, and thus the depressing part 21 of the operation pedal 20 can be reliably prevented from displacing toward the vehicle rear side.

In the brake pedal device 1, since the second support shaft 13 is arranged on the vehicle rear side relative to the first support shaft 12 in the side plate 11 of the pedal bracket 10, the operation pedal 20 is arranged on the vehicle front side, and the intermediate lever 25 is arranged on the vehicle rear side (see FIGS. 1-6). In the brake pedal device 1 as such described above, when the opening for preventing rearward movement 16 and the movement allowing part 17 are formed on the vehicle rear side relative to the second shaft hole 15, the operation pedal 20 can be forcibly pivoted so as to move the depressing part 21 of the operation pedal 20 toward the vehicle front side by moving the second support shaft 13 toward the opening for preventing rearward movement 16 accompanying with the collision.

### Second Embodiment

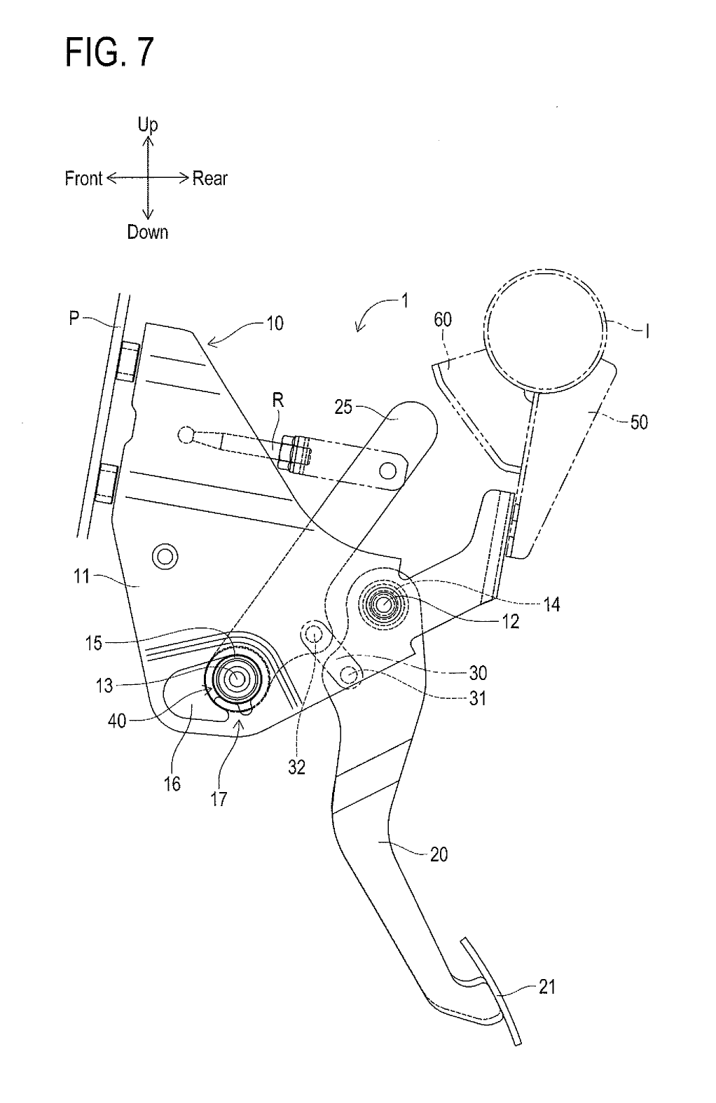

Next, a schematic configuration of the brake pedal device 1 according to the embodiment different from the above first embodiment (the second embodiment) will be described in detail with reference to FIGS. 7-11. Incidentally, the brake pedal device 1 according to the second embodiment includes the same configuration as the brake pedal device 1 according to the above first embodiment except for arrangements of the operation pedal 20 and the intermediate lever 25 and the configuration in the vicinity of the second shaft hole 15. Accordingly, in the below description, the description on the same configuration as the first embodiment will be omitted, and the different configuration will be described in detail.

(Schematic Configuration of the Brake Pedal Device According to the Second Embodiment)

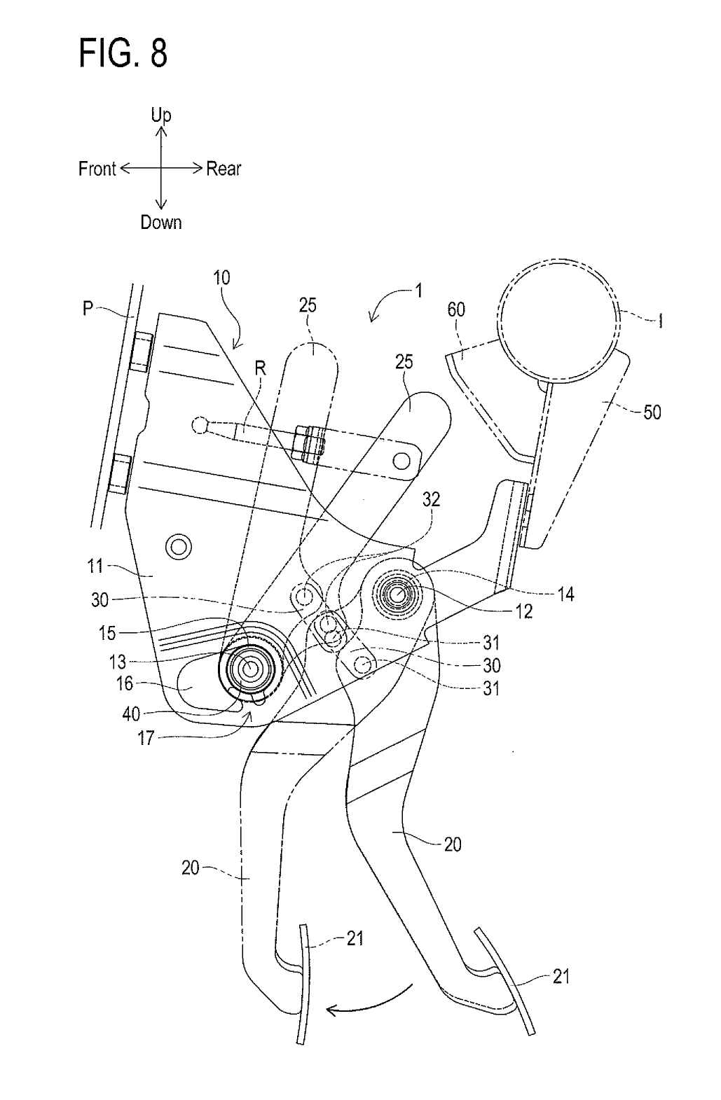

As illustrated in FIGS. 7 and 8, in the brake pedal device 1 according to the second embodiment, the pedal bracket 10 is also secured to the vehicle compartment side of the dash panel P at the vehicle front side part using a bolt etc., and is fastened and fixed with respect to the fastening bracket 50 fixed to the instrument panel reinforcement I at the vehicle rear side part with a bolt and a nut. Then, the pedal bracket 10 includes the pair of side plates 11 that faces with each other with the gap in the vehicle width direction, the first support shaft 12 and the second support shaft 13 as in the case with the first embodiment.

In the second embodiment, the first support shaft 12 extends substantially horizontally and substantially parallel with the vehicle width direction between the pair of side plates 11 in the pedal bracket 10. The first support shaft 12 is arranged by inserting through the first shaft hole 14 formed in the pedal bracket 10. Then, the second support shaft 13 according to the second embodiment is located on the vehicle front side relative to the operation pedal 20. The second support shaft 13 is arranged to extend parallel to the first support shaft 12. The second support shaft 13 is arranged by inserting through the second shaft hole 15 formed on the vehicle front side relative to the first shaft hole 14 in each of the side plate 11 of the pedal bracket 10. Specifically, the second support shaft 13 is fixed to the pedal bracket 10 by caulking in the state where the second support shaft 13 is inserted through the cylindrical member 40 press fitted into the second shaft hole 15 in each of the side plate 11 of the pedal bracket 10.

The opening for preventing rearward movement 16 and the movement allowing part 17 according to the second embodiment are formed at a vehicle front side part of the vicinity of the second shaft hole 15. The movement allowing part 17 performs the function of holding the second support shaft 13 arranged with the cylindrical member 40 into the second shaft hole 15 even when the depressing operation of the operation pedal 20 is performed, and the function of allowing the movement of the second support shaft 13 and the cylindrical member 40 toward the opening for preventing rearward movement 16 when the load due to the vehicle collision etc. acts. Specific configurations of the opening for preventing rearward movement 16 and the movement allowing part 17 according to the second embodiment will be described in detail later with reference to the drawings.

The operation pedal 20 includes the upper part pivotally supported by the first support shaft 12 located on the vehicle rear side of the pedal bracket 10 and includes the depressing part 21 at the lower end part. Accordingly, when the depressing operation is performed by the depressing part 21, the operation pedal 20 pivots with the first support shaft 12 as the center.

As illustrated in FIGS. 7 and 8, the intermediate lever 25 includes the lower end part pivotally supported by the second support shaft 13 arranged on the vehicle front side of the pedal bracket 10 and extends upwardly. The operating rod R is coupled to the upper end part of the intermediate lever 25 via the clevis. The coupling link 30 couples the upper front side part of the operation pedal 20 to the lower rear side part of the intermediate lever 25 and is pivotally attached to the operation pedal 20 and the intermediate lever 25.

Then, in the second embodiment, the cylindrical member 40 is also the member arranged into the second shaft hole 15 in the state where the cylindrical member 40 is inserted by the second support shaft 13 and includes the cylindrical part 41 and the flange part 42 as in the case with the first embodiment. As described above, the cylindrical member 40 is formed of the hard resin material. The cylindrical member 40 is inserted by the second support shaft 13 in the state where the cylindrical member 40 is press fitted into the second shaft hole 15.

(Force Acting on Each of the Unit of the Brake Pedal Device 1 According to the Second Embodiment)

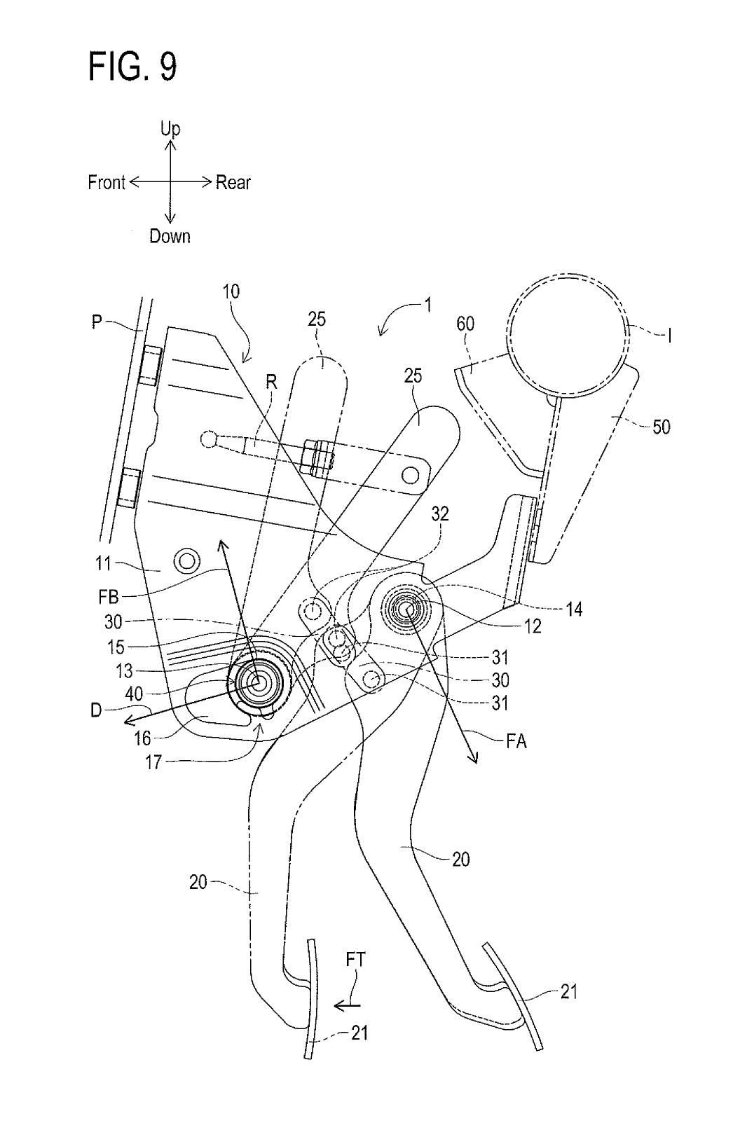

Subsequently, a force acting on each of the unit of the brake pedal device 1 in the depressing operation will be described with reference to FIG. 9. Incidentally, in the below description, the road surface load FT is defined as in the case with above first embodiment.

As illustrated in FIG. 9, when the road surface load FT acts on the depressing part 21 of the operation pedal 20, and then the depressing operation is performed, the operation pedal 20 pivots with the first support shaft 12 as the center, and thus a load acts on the connection pin 31 of the coupling link 30. Accordingly, the first load FA acts on the first support shaft 12 following the depressing operation of the operation pedal 20. The first load FA can be calculated by the resultant force of the road surface load FT and the load acting on the connection pin 31, and the magnitude and the direction of the first load FA can be specified.

Then, since the intermediate lever 25 is coupled to the operation pedal 20 via the coupling link 30, the intermediate lever 25 pivots with the second support shaft 13 as the center in conjunction with the depressing operation of the operation pedal 20. Accordingly, in the intermediate lever 25, a load acts on the connection pin 32 of the coupling link 30. The load acting on the connection pin 32 is a reaction force of the load input to the connection pin 31.

And, the intermediate lever 25 pivots with the second support shaft 13 as the center to displace the operating rod R of the brake booster toward the output direction. Accordingly, a reaction force of the load when the operating rod R is displaced toward the output direction is input to the upper part of the intermediate lever 25. Therefore, the second load FB acts on the second support shaft 13 by the pivoting of the intermediate lever 25 following the depressing operation of the operation pedal 20. The second load FB can be calculated by the resultant force of the load acting on the connection pin 32 and the load input to the intermediate lever 25 when the operating rod R is displaced, and the magnitude and the direction of the second load FB can be specified.

In the brake pedal device 1 according to the second embodiment, the opening for preventing rearward movement 16 and the movement allowing part 17 are also formed according to the direction of the second load FB acting on the second support shaft 13 and the separating direction D determined by the second load FB with reference to the second shaft hole 15. The above will be described later with reference to the drawings.

(Configuration in the Vicinity of the Second Shaft Hole 15 of the Brake Pedal Device According to the Second Embodiment)

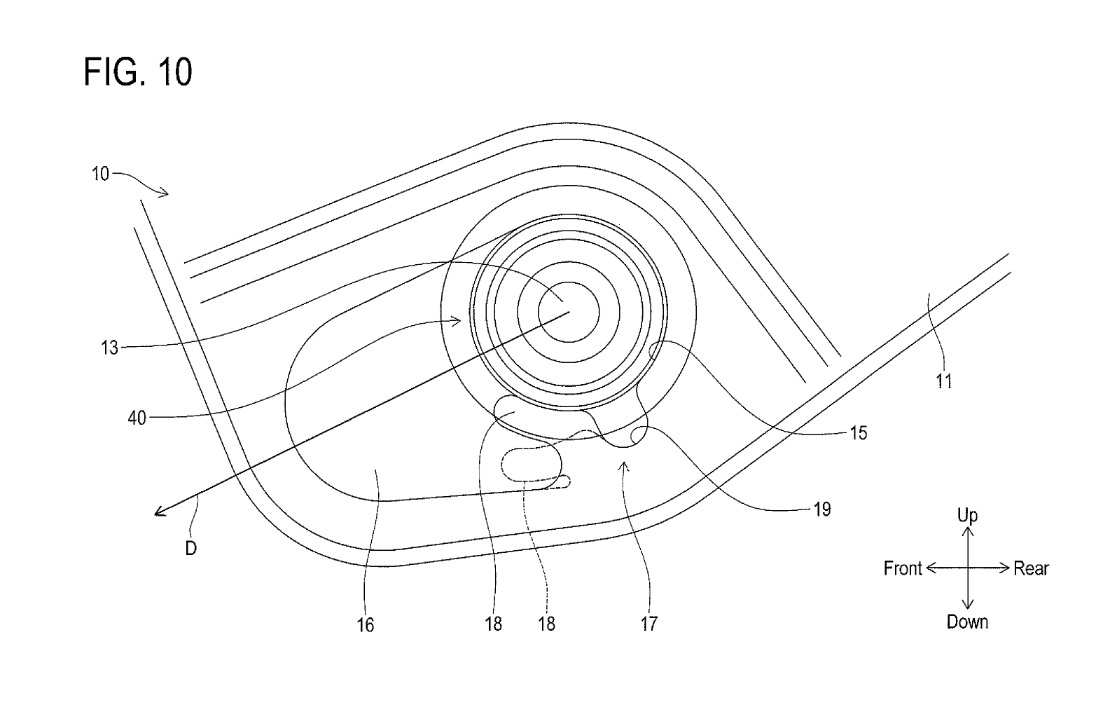

In the brake pedal device 1 according to the second embodiment, the opening for preventing rearward movement 16 and the movement allowing part 17 are also formed in the vicinity of the second shaft hole 15. The configuration in the vicinity of the second shaft hole 15 according to the second embodiment will be described in detail with reference to FIG. 10.

As illustrated in FIG. 10, the opening for preventing rearward movement 16 is formed on the downstream side in the separating direction D with respect to the second shaft hole 15 and is located on the vehicle front side with respect to the second shaft hole 15. The opening for preventing rearward movement 16 is configured so as to be partly communicated with the second shaft hole 15. In the second embodiment, the separating direction D is also a direction substantially orthogonal to the second load FB acting on the second support shaft 13 in the depressing operation of the operation pedal 20 (see FIG. 9), and indicates a direction substantially equal to a direction of the load acting on the second support shaft 13 when the dash panel P is displaced toward the vehicle rear side due to the vehicle collision.

Then, the movement allowing part 17 is formed between the second shaft hole 15 and the opening for preventing rearward movement 16 in the separating direction D and is configured to include the holding protrusion 18 and the cutout part 19. The holding protrusion 18 according to the second embodiment is a protruding piece formed so as to protrude from the opening edge (i.e. opening edge on the lower side) opposite to the side where the second load FB acts on the opening edge of the second shaft hole 15 and abuts on the second support shaft 13 and the cylindrical member 40 held into the second shaft hole 15 from a side of the separating direction D. Accordingly, the holding protrusion 18 performs the function of holding the second support shaft 13 and the cylindrical member 40 into the second shaft hole 15.

And, since the holding protrusion 18 is formed so as to protrude from the opening edge (i.e. opening edge on the lower side) opposite to the side where the second load FB acts on the opening edge of the second shaft hole 15, the holding protrusion 18 can hold the second support shaft 13 etc. into the second shaft hole 15 without deformation due to the load (i.e. the second load FB) in the depressing operation of the operation pedal 20.

Then, the cutout part 19 according to the second embodiment is configured by cutting out the base end of the holding protrusion 18 in the opening edge (i.e. opening edge on the lower side) opposite to the side where the second load FB acts on the opening edge of the second shaft hole 15. Since the cutout part 19 can decrease the cross-sectional area at the base end of the holding protrusion 18, the holding protrusion 18 can be deformed largely with the cutout part 19 as the starting point by the second support shaft 13 and the cylindrical member 40 moving from the second shaft hole 15 to the opening for preventing rearward movement 16.

In the second embodiment, the cylindrical member 40 is also formed of the hard resin material. The cylindrical member 40 includes the cylindrical part 41 and the flange part 42. The cylindrical part 41 is a part to be press fitted into the second shaft hole 15 and is brought into pressure contact with the opening edge of the second shaft hole 15 etc. Accordingly, the cylindrical part 41 is arranged between the outer periphery of the second support shaft 13 and the opening edge of the second shaft hole 15.

Then, the flange part 42 is formed so as to extend from the outer peripheral surface of the cylindrical part 41 toward the outside in the radial direction and is arranged along the side plate 11 of the pedal bracket 10 when the cylindrical member 40 is press fitted into the second shaft hole 15. The cylindrical member 40 is press fitted into the second shaft hole 15 from the inside of the pedal bracket 10, and the flange part 42 is arranged along the inner surface of the side plate 11 in the pedal bracket 10.

At the time of vehicle collision, when the second support shaft 13 etc. moves from the second shaft hole 15 toward the opening for preventing rearward movement 16, the flange part 42 can be moved along the side plate 11 of the pedal bracket 10 regardless of the shape of the opening edge in a part moving from the second shaft hole 15 toward the opening for preventing rearward movement 16. Accordingly, the flange part 42 of the cylindrical member 40 functions as a guide when the second support shaft 13 etc. moves from the second shaft hole 15 toward the opening for preventing rearward movement 16.

(Movement of the Brake Pedal Device According to the Second Embodiment at the Time of Vehicle Collision)

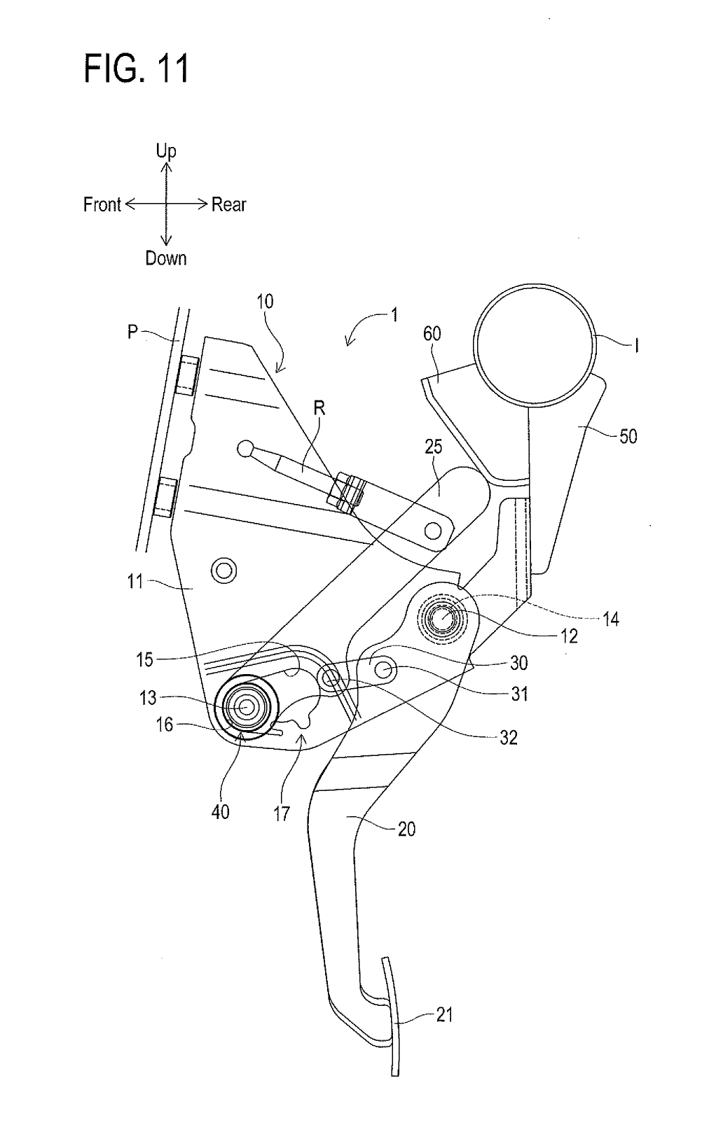

Next, the operation of the brake pedal device 1 according to the second embodiment at the time of vehicle collision will be described in detail with reference to FIG. 11. When the large load is input from the vehicle front side due to the vehicle collision etc. in the second embodiment, the dash panel P is displaced toward the vehicle rear side by the input large load. At this time, the brake pedal device 1 according to the second embodiment relatively moves toward the vehicle rear side as a whole while deforming a rear part of the pedal bracket 10 (see FIGS. 7 and 11).

Then, the bracket for collision 60 is fixed to the instrument panel reinforcement I and is arranged on the vehicle rear side relative to the intermediate lever 25. Accordingly, when the whole brake pedal device 1 relatively moves toward the vehicle rear side following the displacement of the dash panel P toward the vehicle rear side and the deformation of the pedal bracket 10, the bracket for collision 60 abuts on the upper part of the intermediate lever 25.

Here, a front surface of the bracket for collision 60 inclines downwardly toward the vehicle rear side. Then, when the whole brake pedal device 1 relatively moves toward the vehicle rear side, the upper part of the intermediate lever 25 moves gradually downwardly along the front surface of the bracket for collision 60 without displacing the operating rod R toward the vehicle front side.

In the second embodiment, since the lower end part of the intermediate lever 25 is also supported by the second support shaft 13, the load due to the vehicle collision acts on the second support shaft 13 toward the vehicle front side through the bracket for collision 60. Thereby, the load due to the vehicle collision acts on the holding protrusion 18 through the second support shaft 13 and the cylindrical member 40 and deforms the holding protrusion 18 with the cutout part 19 as the starting point (see FIG. 10). As a result, the second support shaft 13 and the cylindrical member 40 move toward the separating direction D while deforming the holding protrusion 18 with the load due to the vehicle collision, moving from the second shaft hole 15 into the opening for preventing rearward movement 16 (see FIG. 11).

When the second support shaft 13 moves from the second shaft hole 15 toward the opening for preventing rearward movement 16 following the rearward displacement of the dash panel P, a distance between the first support shaft 12 and the second support shaft 13 becomes larger. In the second embodiment, the operation pedal 20 supported by the first support shaft 12 is also coupled to the intermediate lever 25 supported by the second support shaft 13 via the coupling link 30. Accordingly, when the second support shaft 13 etc. move from the second shaft hole 15 toward the opening for preventing rearward movement 16, the operation pedal 20 is pulled by the coupling link 30, thereby forcibly pivoting around the first support shaft 12. As a result, according to the brake pedal device 1, even when the operating rod R is not able to be displaced toward the vehicle front side, the depressing part 21 of the operation pedal 20 can be prevented from moving rearward toward the driver's seat side by moving the second support shaft 13 from the second shaft hole 15 toward the opening for preventing rearward movement 16 accompanying with the front vehicle collision.

As explained above, as in the case with the first embodiment, the brake pedal device 1 according to the second embodiment includes the pedal bracket 10, the operation pedal 20, the intermediate lever 25, and coupling link 30, and can pivot the intermediate lever 25 via the coupling link 30 in conjunction with the pivoting of the operation pedal 20 in the depressing operation, thereby displacing the operating rod R of the brake booster toward the vehicle front side.

In the brake pedal device 1, each of the side plate 11 of the pedal bracket 10 includes the opening for preventing rearward movement 16 and the movement allowing part 17, and the opening for preventing rearward movement 16 is configured to be in the separating direction D that is a direction of the load acting on the second support shaft 13 at the time of vehicle collision with respect to the second shaft hole 15. Then, the movement allowing part 17 holds the second support shaft 13 into the second shaft hole 15 and allows the movement of the second support shaft 13 toward the opening for preventing rearward movement 16 when the load at the time of vehicle collision acts. Accordingly, according to the brake pedal device 1, when the load at the time of vehicle collision acts, the second support shaft 13 supporting the intermediate lever 25 can be moved from the second shaft hole 15 toward the opening for preventing rearward movement 16 through the movement allowing part 17.

Here, since the intermediate lever 25 is coupled to the operation pedal 20 via the coupling link 30, the operation pedal 20 forcibly pivots around the first support shaft 12 following the movement of the second support shaft 13 toward the opening for preventing rearward movement 16 through the movement allowing part 17. That is, according to the brake pedal device 1, the depressing part 21 of the operation pedal 20 can be forcibly pivoted without displacing the operating rod R toward the front side by moving the second support shaft 13 toward the opening for preventing rearward movement 16 through the movement allowing part 17 with the load at the time of vehicle collision.

And, in the brake pedal device 1, since the movement allowing part 17 performs the function of holding the second support shaft 13 into the second shaft hole 15, the second support shaft 13 does not move toward the opening for preventing rearward movement 16 in the depressing operation of the operation pedal 20. That is, according to the brake pedal device 1, the depressing operation of the operation pedal 20 can be reliably performed without moving the second support shaft 13.

In the brake pedal device 1, the movement allowing part 17 includes the holding protrusion 18 and the cutout part 19. The holding protrusion 18 is configured to protrude from the opening edge of the second shaft hole 15 on the side opposite to the side where the load (i.e. the second load FB) acts on the second support shaft 13 in the depressing operation of the operation pedal 20. Accordingly, the second support shaft 13 can be held into the second shaft hole 15 without deforming the holding protrusion 18 with the load of the depressing operation when the depressing operation of the operation pedal 20 is performed.

Then, since the cutout part 19 is configured to form on the base end of the holding protrusion 18, the holding protrusion 18 is reliably deformed with the cutout part 19 as the starting point when the load in a direction different from the depressing operation (i.e. the load at the time of vehicle collision) acts. The second support shaft 13 can move from the second support hole 15 toward the opening for preventing rearward movement 16 due to the deformation of the holding protrusion 18 with the cutout part 19 as the starting point. That is, according to the brake pedal device 1, the second support shaft 13 can be reliably moved toward the opening for preventing rearward movement 16 when the load due to the vehicle collision acts. That is, according to the brake pedal device 1, the depressing part 21 of the operation pedal 20 can be prevented from displacing toward the vehicle rear side without displacing the operating rod R toward the vehicle front side.

The brake pedal device 1 includes the cylindrical member 40, and the cylindrical member 40 is inserted by the second support shaft 13 and arranged to the second shaft hole 15. The cylindrical member 40 includes the cylindrical part 41 and the flange part 42. The cylindrical part 41 is arranged between the outer periphery of the second support shaft 13 and the opening edge of the second shaft hole 15. And, the flange part 42 extends from the cylindrical part 41 toward the outside in the radial direction and is arranged along the side plate 11 and the flange part 42 moves along the side plate 11 of the pedal bracket 10 when the second support shaft 13 moves toward the opening for preventing rearward movement 16 accompanying with the vehicle collision. That is, according to the brake pedal device 1, the second support shaft 13 can be smoothly and reliably moved toward the opening for preventing rearward movement 16 by the cylindrical member 40 accompanying with the vehicle collision, and thus the depressing part 21 of the operation pedal 20 can be reliably prevented from displacing toward the vehicle rear side.

In the brake pedal device 1, since the second support shaft 13 is arranged on the vehicle front side relative to the first support shaft 12 in the side plate 11 of the pedal bracket 10, the intermediate lever 25 is arranged on the vehicle front side, and the operation pedal 20 is arranged on the vehicle rear side (see FIGS. 7-11). In the brake pedal device 1 as such described above, when the opening for preventing rearward movement 16 and the movement allowing part 17 are formed on the vehicle front side relative to the second shaft hole 15, the operation pedal 20 can be forcibly pivoted so as to move the depressing part 21 of the operation pedal 20 toward the vehicle front side by moving the second support shaft 13 toward the opening for preventing rearward movement 16 accompanying with the collision.

### Third Embodiment

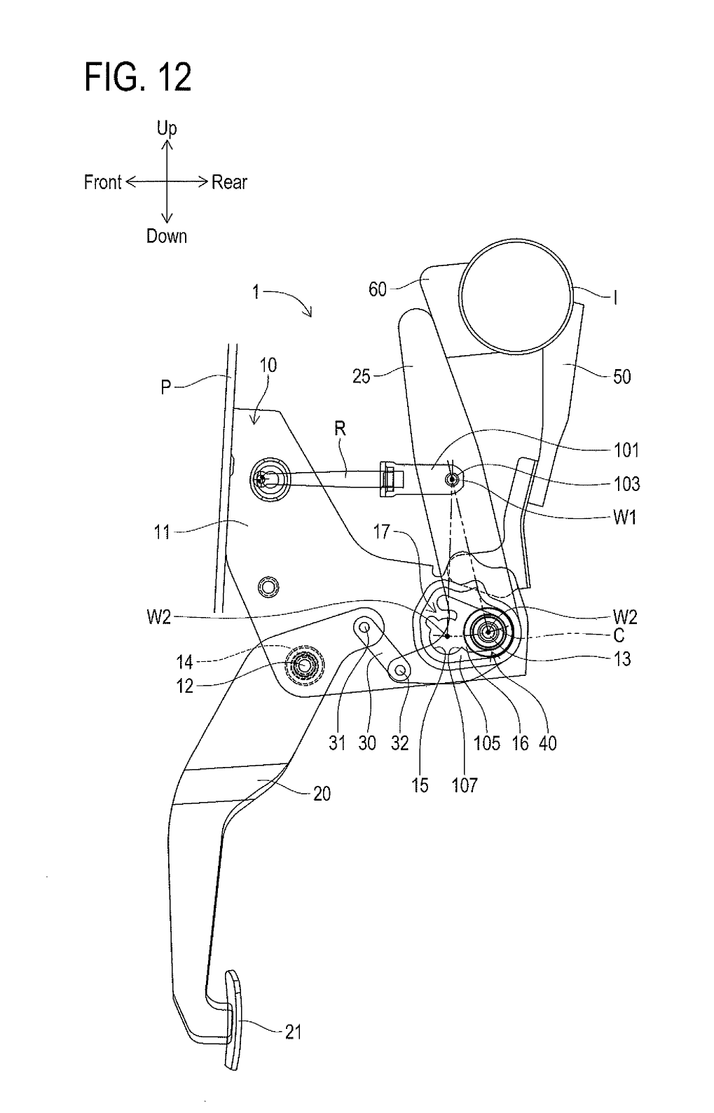

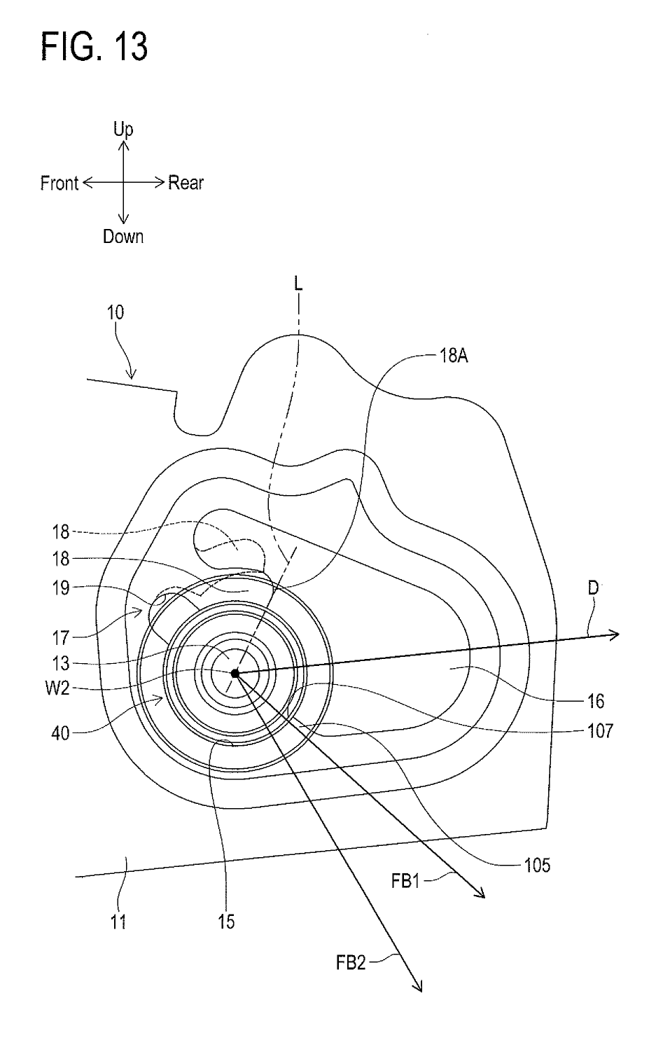

Next, the brake pedal device 1 according to the third embodiment will be described in detail with reference to FIGS. 12 and 13. The brake pedal 1 according to the third embodiment includes the same configuration as the brake pedal device 1 according to the above first embodiment except for a configuration in the vicinity of the second shaft hole 15. Accordingly, in the below description, the same reference signs are followed in parts substantially in common with the above first embodiment, and the detailed description will be omitted.

As illustrated in FIG. 12, as in the case with the first embodiment, the operating rod R is coupled to the upper part of the intermediate lever 25 via a clevis 101. In the coupling, the intermediate lever 25 and the clevis 101 are pivotally supported by a third support shaft 103. Thereby, the intermediate lever 25 can be pivoted with respect to the operating rod R.

In the third embodiment, assuming a circumference C defining an axis W1 of the third support shaft 103 as a center, the circumference C further defining a distance between the axis W1 of the third support shaft 103 and an axis W2 of the second support shaft 13 in the second shaft hole 15 as a radius, the opening for preventing rearward movement 16 is arranged in a direction of a tangent of the circumference C in the axis W2 of the second support shaft 13 held into the second shaft hole 15, i.e. the separating direction D illustrated in FIG. 13 with respect to the second shaft hole 15.

As illustrated in FIGS. 12 and 13, as in the case with the first embodiment, the opening for preventing rearward movement 16 is configured so as to be partly communicated with the second shaft hole 15. In an opening edge of a boundary position partly communicating the opening for preventing rearward movement 16 with the second shaft hole 15, a projecting edge part 105 is protrudingly formed. The projecting edge part 105 is provided with a slope 107 located higher from the second shaft hole 15 toward the opening for preventing rearward movement 16, i.e. toward the vehicle rear side.

As illustrated in FIG. 13, in the depressing operation of the operation pedal 20, the second load FB1, FB2 act on the second support shaft 13 held into the second shaft hole 15. An arrow of the second load FB1 indicates the direction of the load acting on the second support shaft 13 at a moment when the depressing operation of the operation pedal 20 is performed. The arrow of the second load FB2 indicates the direction of the load acting on the second support shaft 13 when the depressing operation of the operation pedal 20 is performed with a full stroke. Accordingly, the load in the direction of a range held by the both arrows of the second load FB1 and FB2 acts on the second support shaft 13 held into the second shaft hole 15 while the depressing operation of the operation pedal 20 is performed with a stroke in the whole range.

The projecting edge part 105 is protrudingly formed from the opening edge on a side where the second load FB1, FB2 act in the opening edge at the boundary position partly communicating the opening for preventing rearward movement 16 with the second shaft hole 15. The slope 107 of the projecting edge 105 is formed so as to incline by 90 degrees or more with respect to the directions of the second load FB1, FB2. That is, although the load in either direction in the range held by the both arrows of the second load FB1, FB2 acts on the second support shaft 13 held into the second shaft hole 15 when the depressing operation of the operation pedal 20 is performed, the slope 107 of the projecting edge 105 is formed so as to incline by 90 degrees or more from reference even if the either direction in the range held by the both arrows of the second load FB1, FB2 is defined as the reference.

The holding protrusion 18 is formed so as to protrude from the second shaft hole 15 on the opening edge opposite to the side where the second load FB1, FB2 act (i.e. the opening edge on the upper side). A position of a tip 18A of the holding protrusion 18 is designed to satisfy a relative relationship as described below. Assuming a straight line L connecting the tip 18A of the holding protrusion 18 to the axis W2 of the second support shaft 13 held into the second shaft hole 15, the relative relationship is a relationship in which the straight line L intersects the directions of the second load FB1, FB2 in the axis W2 of the second support shaft 13 held into the second shaft hole 15, and an angle on the opening for preventing rearward movement 16 side at an intersection point thereof (i.e. the axis W2 of the second support shaft 13 held into the second shaft hole 15) is 90 degrees or more. In other words, the above relationship is a relationship in which the angle formed by placing the opening for preventing rearward movement 16 between the straight line L and both of the second load FB1, FB2 is set to 90 degrees or more. That is, although the load in the either direction in the range held by both arrows of the second load FB1, FB2 acts on the second support shaft 13 held into the second shaft hole 15 in the depressing operation of the operation pedal 20, the angle on the opening for preventing rearward movement 16 side at the intersection point is 90 degrees or more even if the straight line L intersects the either direction in the range held by the both arrows of the second load FB1, FB2.

As described above, the brake pedal device 1 according to the third embodiment includes the third support shaft 103 pivotally supporting the intermediate lever 25 with respect to the operating rod R. As in the case with the first embodiment, the operating rod R can be in a situation where the operating rod R is not able to be displaced toward the vehicle front side due to the medium pressure etc. in the brake booster at the time of vehicle collision. Thus, the intermediate lever 25 forcibly pivots with the axis W1 of the third support shaft 103 as the center in a situation where the operating rod R is not displaced, i.e. a situation where the third support shaft 103 is not displaced at the time of vehicle collision. The second support shaft 13 pivotally supported by the lower part of the intermediate lever 25 moves from the second shaft hole 15 to the opening for preventing rearward movement 16 following the pivoting of the intermediate lever 25.

At this time, the second support shaft 13 moves on the circumference C defining the distance between the axis W2 of the second support shaft 13 held into the second shaft hole 15 and the axis W1 of the third support shaft 103 as the radius and the axis W1 of the third support shaft 103 as the center. Further, the opening for preventing rearward movement 16 is located in the direction of the tangent on the circumference C in the axis W2 of the second support shaft 13 held into the second shaft hole 15, i.e. the separating direction D with respect to the second shaft hole 15. Accordingly, when the second support shaft 13 moves on the circumference C, the second support shaft 13 moves the opening for preventing rearward movement 16. Therefore, according to the brake pedal device 1 in the third embodiment, since the second support shaft 13 smoothly moves the opening for preventing rearward movement 16 at the time of vehicle collision and a sliding resistance due to the movement of the second support shaft 13 is hardly generated, an effect of separating the second support shaft 13 from the second shaft hole 15, i.e. a load efficiency can be improved.

The brake pedal device 1 according to the third embodiment includes the projecting edge part 105. The projecting edge part 105 is configured to protrude on the side where the second load FB1, FB2 act in the boundary position partly communicating the second shaft hole 15 with the opening for preventing rearward movement 16. Further, the projecting edge part 105 is provided with the slope 107 located higher from the second shaft hole 15 toward the opening for preventing rearward movement 16 and inclining by 90 degrees or more with respect to the either direction in the range held by the both arrows of the second load FB1, FB2. Therefore, even if a direction of a load acting on the second support shaft 13 in the depressing operation of the operation pedal 20 is the either direction in the range held by the both arrows of the second load FB1, FB2, the slope 107 of the projecting edge part 105 inclines by 90 degrees or more with respect to the direction of the load. Accordingly, even if the load acts on the second support shaft 13 held into the second shaft hole 15 in the depressing operation of the operation pedal 20, a force to climb up the slope 107 of the projecting edge part 105 does not act on the second shaft hole 15.

As described above, since in the brake pedal device 1 according to the third embodiment, the force acting on the second support shaft 13 held into the second shaft hole 15 to climb up the slope 107 of the projecting edge part 105 is prevented from generating due to the load in the depressing operation of the operation pedal 20, under normal conditions such as the depressing operation of the operation pedal 20, the second support shaft 13 can be held into the second shaft hole 15. That is, the second support shaft 13 can be held into the second shaft hole 15 even at a moment when the depressing operation of the operation pedal 20 is performed.

In the brake pedal device 1 according to the third embodiment, even if the direction of the load acting on the second support shaft 13 held into the second shaft hole 15 in the depressing operation of the operation pedal 20 is the either direction in the range held by the both arrows of the second load FB1, FB2, the opening for preventing rearward movement 16 is placed between the direction and the straight line L connecting the axis W2 of the second support shaft 13 held into the second shaft hole 15 to the tip 18A of the holding protrusion 18, and the angle formed by placing the opening for preventing rearward movement 16 therebetween is set to 90 degrees or more. Since the tip 18A of the holding protrusion 18 is arranged so as to satisfy the above relative relationship, a force in the direction of the straight line L, i.e. a force from the axis W2 of the second support shaft 13 held into the second shaft hole 15 toward the tip 18A of the holding protrusion 18 does not act due to the load acting on the second support shaft 13 in the depressing operation of the operation pedal 20.

As described above, since in the brake pedal device 1 according to the third embodiment, a force acted to deform the holding protrusion 18 is prevented from generating due to the load of the depressing operation of the operation pedal 20, under normal conditions such as the depressing operation of the operation pedal 20, the second support shaft 13 can be held into the second shaft hole 15. That is, the second support shaft 13 can be held into the second shaft hole 15 even at a moment when the depressing operation of the operation pedal 20 is performed.

### Fourth Embodiment

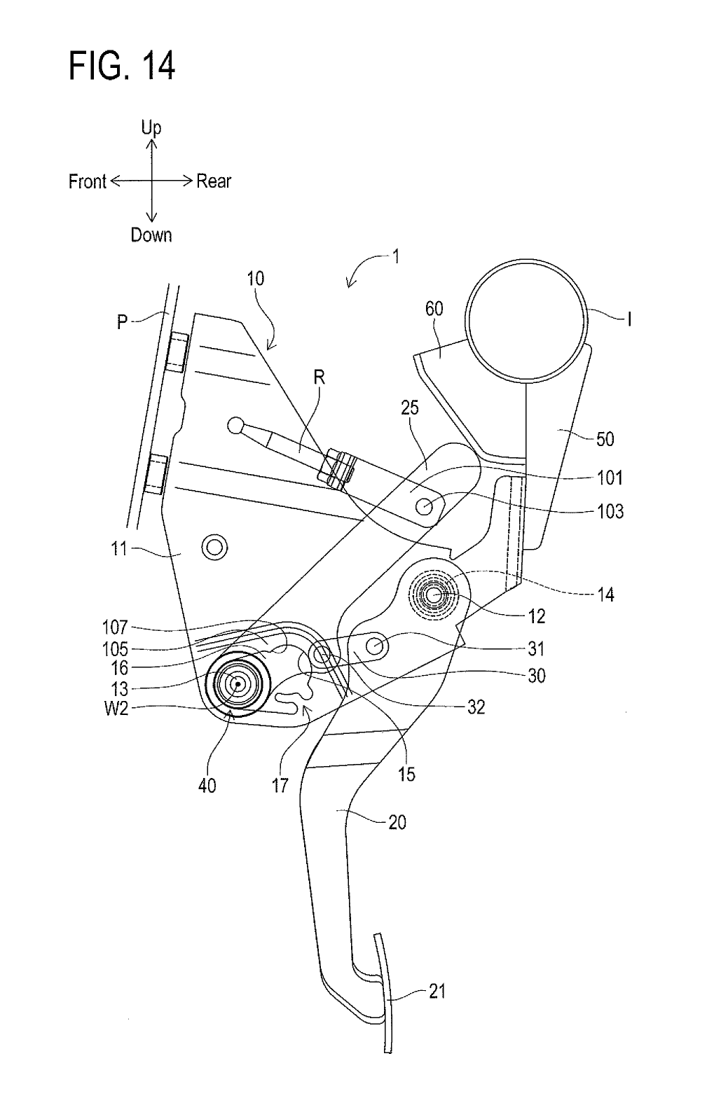

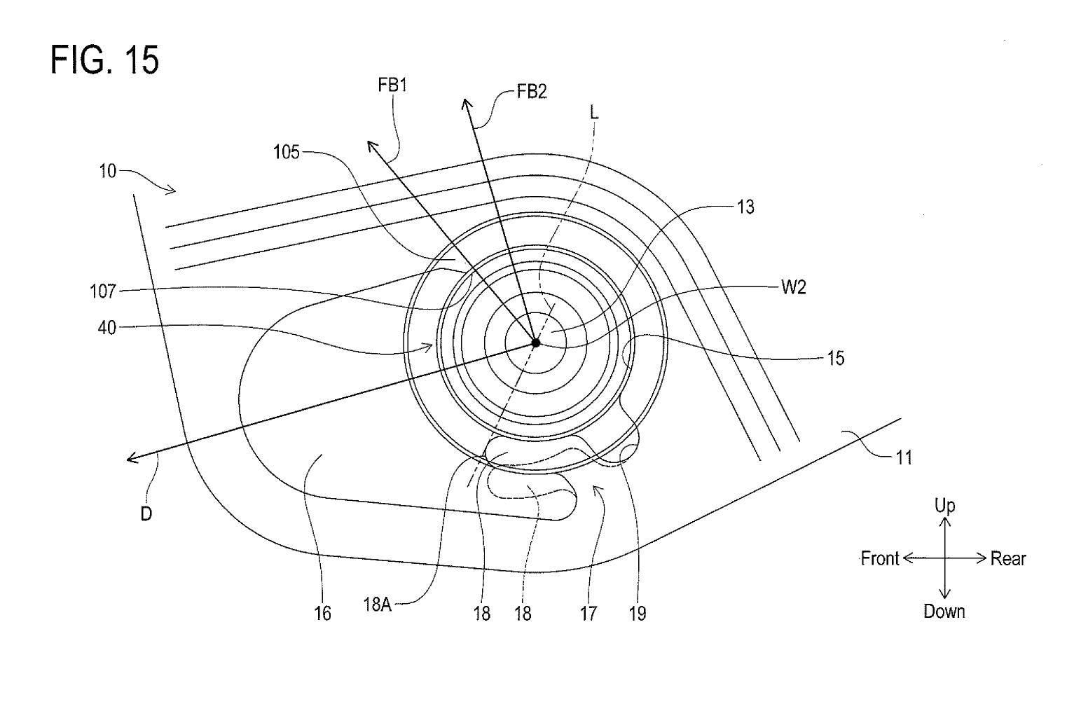

Next, the brake pedal device 1 according to the fourth embodiment will be described in detail with reference to FIGS. 14 and 15. The brake pedal device 1 according to the fourth embodiment includes the same configuration as the brake pedal device 1 according to the above second embodiment except for the configuration in vicinity of the second shaft hole 15. In the below description, the same reference signs are followed in parts substantially in common with the above second embodiment, and the detailed description will be omitted.

Further, except for the following point, the configuration in vicinity of the second shaft hole 15 is the configuration wherein the projecting edge part 105 (including the slope 107) is provided, and (the tip 18A of) the holding protrusion 18 is arranged as in the case with the above third embodiment. In the below description, the same reference signs are followed in parts substantially in common with the above third embodiment, and the detailed description will be omitted.

In the brake pedal device 1 according to the fourth embodiment, since opening for preventing rearward movement 16 is located on the vehicle front side relative to the second shaft hole 15, i.e. on the side opposite to the vehicle rear side in the above third embodiment, the directions of the second load FB1, FB2 are directed to a vehicle upper side that is opposite to the direction in the above third embodiment (i.e. a vehicle lower side).

Accordingly, the projecting edge part 105 is provided at the opening edge on the upper side in the opening edge at the boundary position partly communicating the opening for preventing rearward movement 16 with the second shaft hole 15, which is opposite to the opening edge on the lower side in the above third embodiment. And the holding protrusion 18 is provided at the opening edge on the lower side in the opening edge of the second shaft hole 15, which is opposite to the opening edge on the upper side in the above third embodiment.

In the brake pedal device 1 according to the fourth embodiment as such described above, under normal conditions such as the depressing operation of the operation pedal 20, the second support shaft 13 can be also held into the second shaft hole 15 as in the case with the above third embodiment. That is, the second support shaft 13 can be held into the second shaft hole 15 even at a moment when the depressing operation of the operation pedal 20 is performed.

(Others)

In the present embodiment, the brake pedal device 1 is one example of “a rearward movement preventing device of a pedal device for vehicle”. The second shaft hole 15 is one example of “a shaft hole”. The holding protrusion 18 is one example of “a protrusion part”. The separating direction D is one example of “a direction of tangent”.

(Variations)

The present disclosure has been described based on the embodiment hereinabove, however this is purely one embodiment and the present disclosure can be performed with a variety of modifications and improvements within a range without departing from the spirit of the present disclosure. For example, in the above-mentioned embodiment, although the movement allowing part 17 is constituted of the one holding protrusion 18 and the one cutout part 19, the present disclosure is not limited to this configuration. Various modes can be adapted to the configuration of the movement allowing part 17 if the second support shaft 13 is held into the second shaft hole 15 and the movement of the second support shaft 13 toward the opening for preventing rearward movement 16 can be allowed when the load at the time of vehicle collision acts. For example, the movement allowing part 17 can be constituted of the additional one holding protrusion 18 and one cutout part 19 at a position facing the one holding protrusion 18 and the one cutout part 19 according to the above embodiment.

And, in the above embodiment, although the second support shaft 13 is attached to the pedal bracket 10 by caulking, the present disclosure is not limited to this configuration. For example, the second support shaft 13 may be constituted of a bolt and a nut and may be fastened and fixed to the pedal bracket 10.

Then, in the above embodiment, although the cylindrical member 40 is formed of the hard resin material, a constituent material of the cylindrical member in the present disclosure is not limited to the above-mentioned material, and various kinds of materials can be employed. In the above embodiment, although the cylindrical member 40 is press fitted into the second shaft hole 15, the present disclosure is not limited to this configuration. If the cylindrical part 41 of the cylindrical member 40 can be arranged inside the second shaft hole 15, various modes can be adapted.

And, in the above embodiment, although the flange part 42 of the cylindrical member 40 is arranged along surfaces facing with each other in the pair of side plates 11 (inside surface in the pedal bracket 10), the flange part 42 of the cylindrical member 40 can be arranged along surfaces outside the pedal bracket 10 in the pair of side plates 11.

And, If the present disclosure can realize each movement of the rearward movement preventing device of the pedal device for vehicle according to the present disclosure, the present disclosure is not limited to modes described in the above embodiments, and if the each movement of the rearward movement preventing device of the pedal device for vehicle can be realized, arrangements and shapes of each member configuring the brake pedal device 1 can be appropriately changed.

The following description is the list of aspects of the embodiments of the present application.

The first rearward movement preventing device of the pedal device for vehicle is a rearward movement preventing device of a pedal device for vehicle, the pedal device for vehicle including: a pedal bracket configured to fix to a dash panel on a vehicle front side and include a pair of side plates arranged with a gap in a vehicle width direction; an operation pedal configured to pivotally support by a first support shaft arranged in the pair of side plates of the pedal bracket and include a depressing part used for depressing operation toward the vehicle front side; an intermediate lever configured to pivotally support around a second support shaft arranged in parallel with the first support shaft with respect to the pedal bracket, the intermediate lever pivots around the second support shaft toward an output direction to displace a prescribed output member toward the vehicle front side; and a coupling link configured to connect the operation pedal to the intermediate lever and pivot the intermediate lever toward the output direction in conjunction with the depressing operation of the operation pedal; wherein the rearward movement preventing device prevents the depressing part of the operation pedal from displacing toward a vehicle rear side when the dash panel is displaced toward the vehicle rear side, and wherein the pair of side plate of the pedal bracket includes: an opening for preventing rearward movement configured to be in a direction of a load acting on the second support shaft at a time of vehicle collision with respect to a shaft hole of the second support shaft; and a movement allowing part configured to hold the second support shaft into the shaft hole of the second support shaft and allow movement of the second support shaft toward the opening for preventing rearward movement when the load due to the vehicle collision acts.

The first rearward movement preventing device of the pedal device for vehicle includes the pedal bracket, the operation pedal, the intermediate lever, and the coupling link, and can pivot the intermediate lever via the coupling link in conjunction with pivoting of the operation pedal following the depressing operation, thereby displacing the output member toward the vehicle front side. Here, in the first rearward movement preventing device of the pedal device for vehicle, the pair of side plate of the pedal bracket includes the opening for preventing rearward movement and the movement allowing part. The opening for preventing rearward movement is configured to be in the direction of the load acting on the second support shaft at the time of vehicle collision with respect to the shaft hole of the second support shaft. Then, the movement allowing part holds the second support shaft into the shaft hole of the second support shaft and allows movement of the second support shaft toward the opening for preventing rearward movement when the load at the time of vehicle collision acts. Accordingly, according to the first rearward movement preventing device of the pedal device for vehicle, when the load at the time of vehicle collision acts, the second support shaft supporting the intermediate lever can be moved from the shaft hole of the second support shaft toward the opening for preventing rearward movement through the movement allowing part. Here, since the intermediate lever is connected to the operation pedal via the coupling link, the operation pedal forcibly pivots around the first support shaft following movement of the second support shaft toward the opening for preventing rearward movement through the movement allowing part. That is, according to the first rearward movement preventing device of the pedal device for vehicle, the depressing part of the operation pedal can be forcibly pivoted by moving the second support shaft toward the opening for preventing rearward movement through the movement allowing part with the load at the time of vehicle collision. That is, according to the first rearward movement preventing device of the pedal device for vehicle, the depressing part of the operation pedal can be prevented from displacing toward the vehicle rear side without displacing the output member toward the vehicle front side. And, in the firs rearward movement preventing device of the pedal device for vehicle, since the movement allowing part has a function of holding the second support shaft into the shaft hole of the second support shaft, the second support shaft does not move toward the opening for preventing rearward movement in the depressing operation of the operation pedal. That is, according to the first rearward movement preventing device of the pedal device for vehicle, the depressing operation of the operation pedal can be reliably performed without moving the second support shaft.

The second rearward movement preventing device of a pedal device for vehicle is the first rearward movement preventing device of the pedal device for vehicle, wherein the movement allowing part includes: a protrusion part configured to protrude from an opening edge of the shaft hole of the second support shaft on a side opposite to a side where a load acts on the second support shaft and hold the second support shaft into the shaft hole in the depressing operation of the operation pedal; and a cutout part configured to form on a base end of the protrusion part.

In the second rearward movement preventing device of the pedal device for vehicle, the movement allowing part includes the protrusion part and the cutout part. The protrusion part is configured to protrude from the opening edge of the shaft hole of the second support shaft on the side opposite to the side where the load acts on the second support shaft in the depressing operation of the operation pedal. Accordingly, the second support shaft can be held into the shaft hole of the second support shaft without deforming the protrusion part due to the load of the depressing operation when the depressing operation of the operation pedal is performed. Then, since the cutout part is configured to form on the base end of the protrusion part, the protrusion part is reliably deformed with the cutout part as a starting point when a load in a direction different from the depressing operation (i.e. the load at the time of vehicle collision) acts. The second support shaft can move from the shaft hole of the second support shaft toward the opening for preventing rearward movement due to the deformation of the protrusion part with the cutout part as the starting point. That is, according to the second rearward movement preventing device of the pedal device for vehicle, the second support shaft can be reliably moved toward the opening for preventing rearward movement when the load at the time of vehicle collision acts. That is, according to the second rearward movement preventing device of the pedal device for vehicle, the depressing part of the operation pedal can be prevented from displacing toward the vehicle rear side without displacing the output member toward the vehicle front side.

The third rearward movement preventing device of a pedal device for vehicle is the second rearward movement preventing device of the pedal device for vehicle, wherein the protrusion part is provided so that an angle formed by placing the opening for preventing rearward movement between a direction of the load acting on the second support shaft in the depressing operation of the operation pedal and a straight line connecting the second support shaft held into the shaft hole to a tip of the protrusion part is set to 90 degrees or more.

In the third rearward movement preventing device of the pedal device for vehicle, the opening for preventing rearward movement is placed between the direction of the load acting on the second support shaft in the depressing operation of the operation pedal and the straight line connecting the second support shaft held into the shaft hole to the tip of the protrusion part, and the angle formed by placing the opening for preventing rearward movement therebetween is set to 90 degrees or more. When the tip of the protrusion part is arranged as such described above, a force due to the load acting on the second support shaft in the depressing operation of the operation pedal does not act from the second support shaft held into the shaft hole toward the tip of the protrusion part. Accordingly, in the third rearward movement preventing device of the pedal device for vehicle, since a force acted to deform the protrusion part is prevented from generating due to the load of the depressing operation of the operation pedal, the second support shaft can be held into the shaft hole in the depressing operation of the operation pedal. That is, the second support shaft can be held into the shaft hole at a moment when the depressing operation of the operation pedal is performed.

The fourth rearward movement preventing device of a pedal device for vehicle is the first rearward movement preventing device of the pedal device for vehicle, further including a cylindrical member configured to insert by the second support shaft and arrange to the shaft hole of the second support shaft, wherein the cylindrical member includes: a cylindrical part arranged between an outer periphery of the second support shaft and an opening edge of the shaft hole of the second support shaft; and a flange part configured to extend from the cylindrical part toward an outside in a radial direction and arrange along the side plate.

The fourth rearward movement preventing device of the pedal device for vehicle further includes the cylindrical member inserted by the second support shaft and arranged to the shaft hole of the second support shaft. The cylindrical member is configured to include the cylindrical part arranged between the outer periphery of the second support shaft and the opening edge of the shaft hole of the second support shaft, and the flange part. Then, the flange part extends from the cylindrical part toward the outside in the radial direction and is arranged along the pair of side plate of the pedal bracket, and the flange part moves along the pair of side plate of the pedal bracket when the second support shaft moves toward the opening for preventing rearward movement accompanying with the vehicle collision. That is, according to the fourth rearward movement preventing device of the pedal device for vehicle, the second support shaft can be smoothly and reliably moved toward the opening for preventing rearward movement by the cylindrical member accompanying with the vehicle collision, and thus the depressing part of the operation pedal can be reliably prevented from displacing toward the vehicle rear side.

The fifth rearward movement preventing device of a pedal device for vehicle is the first rearward movement preventing device of the pedal device for vehicle, further including a projecting edge part configured to protrude on a side where a load acts on the second support shaft in the depressing operation of the operation pedal in a boundary position continuously provided with the shaft hole and the opening for preventing rearward movement, the projecting edge part provided with a slope located higher from the shaft hole toward the opening for preventing rearward movement, wherein the slope of the projecting edge part inclines by 90 degrees or more with respect to a direction of the load acting on the second support shaft in the depressing operation of the operation pedal.

The fifth rearward movement preventing device of the pedal device for vehicle further includes the projecting edge part, and the projecting edge part is configured to protrude on the side where the load acts on the second support shaft in the depressing operation of the operation pedal in the boundary position continuously provided with the shaft hole and the opening for preventing rearward movement. Further, the projecting edge part is provided with the slope located higher from the shaft hole toward the opening for preventing rearward movement and inclining by 90 degrees or more with respect to the direction of the load acting on the second support shaft in the depressing operation of the operation pedal. Thus, even if the load acts on the second support shaft in the depressing operation of the operation pedal, a force to climb up the slope of the projecting edge part does not act on the second support shaft. Accordingly, in the fifth rearward movement preventing device of the pedal device for vehicle, since the force acting on the second support shaft held into the shaft hole to climb up the slope is prevented from generating due to the load of the depressing operation of the operation pedal, the second support shaft can be held into the shaft hole in the depressing operation of the operation pedal. That is, the second support shaft can be held into the shaft hole even at a moment when the depressing operation of the operation pedal is performed.

The sixth rearward movement preventing device of a pedal device for vehicle is the first rearward movement preventing device of the pedal device for vehicle, further including a third support shaft configured to pivotally support the intermediate lever with respect to the output member, wherein the opening for preventing rearward movement is located in a direction of a tangent in the second support shaft held into the shaft hole on a circumference configured to define a distance between the second support shaft and the third support shaft as a radius and the third support shaft as a center.

The sixth rearward movement preventing device of the pedal device for vehicle includes the third support shaft pivotally supporting the intermediate lever with respect to the output member. At the time of the vehicle collision, the intermediate lever forcibly pivots with the third support shaft as the center in a state where the output member is not displaced, i.e., a state where the third support shaft is not displaced. Following the pivoting, the second support shaft moves from the shaft hole to the opening for preventing rearward movement. At this time, the second support shaft moves on the circumference defining the distance between the second support shaft held into the shaft hole and the third support shaft as the radius and the third support shaft as the center. Further, the opening for preventing rearward movement is located in the direction of the tangent on the circumference in the second support shaft held into the shaft hole. Accordingly, when the second support shaft moves on the circumference, the second support shaft moves the opening for preventing rearward movement. Therefore, according to the sixth rearward movement preventing device of the pedal device for vehicle, since the second support shaft smoothly moves the opening for preventing rearward movement at the time of vehicle collision and a sliding resistance due to the movement of the second support shaft is hardly generated, a load efficiency can be improved.

The seventh rearward movement preventing device of a pedal device for vehicle is the first rearward movement preventing device of the pedal device for vehicle, wherein the second support shaft is arranged on the vehicle rear side relative to the first support shaft in the pair of side plate of the pedal bracket, and wherein the opening for preventing rearward movement and the movement allowing part are formed on the vehicle rear side relative to the shaft hole of the second support shaft.

In the seventh rearward movement preventing device of the pedal device for vehicle, since the second support shaft is arranged on the vehicle rear side relative to the first support shaft in the pair of side plate of the pedal bracket, the operation pedal is arranged on the vehicle front side, and the intermediate lever is arranged on the vehicle rear side. In the seventh rearward movement preventing device of the pedal device for vehicle as such described above, when the opening for preventing rearward movement and the movement allowing part are formed on the vehicle rear side relative to the shaft hole of the second support shaft, the operation pedal can be forcibly pivoted so as to move the depressing part of the operation pedal toward the vehicle front side by moving the second support shaft toward the opening for preventing rearward movement accompanying with the collision.

The eighth rearward movement preventing device of a pedal device for vehicle is the first rearward movement preventing device of the pedal device for vehicle, wherein the second support shaft is arranged on the vehicle front side relative to the first support shaft in the pair of side plate of the pedal bracket, and wherein the opening for preventing rearward movement and the movement allowing part are formed on the vehicle front side relative to the shaft hole of the second support shaft.

In the eighth rearward movement preventing device of the pedal device for vehicle, since the second support shaft is arranged on the vehicle front side relative to the first support shaft in the pair of side plate of the pedal bracket, the intermediate lever is arranged on the vehicle front side, and the operation pedal is arranged on the vehicle rear side. In the eighth rearward movement preventing device of the pedal device for vehicle as such described above, when the opening for preventing rearward movement and the movement allowing part are formed on the vehicle front side relative to the shaft hole of the second support shaft, the operation pedal can be forcibly pivoted so as to move the depressing part of the operation pedal toward the vehicle front side by moving the second support shaft toward the opening for preventing rearward movement accompanying with the collision.

The present disclosure includes the pedal bracket, the operation pedal, the intermediate lever, and the coupling link, and the pair of side plate of the pedal bracket includes the opening for preventing rearward movement and the movement allowing part. The opening for preventing rearward movement is configured to be in the direction of the load acting on the second support shaft at the time of the vehicle collision with respect to the shaft hole of the second support shaft. Then, the movement allowing part holds the second support shaft into the shaft hole of the second support shaft and allows movement of the second support shaft toward the opening for preventing rearward movement when the load at the time of vehicle collision acts. When the dash panel is displaced toward the vehicle rear side, the second support shaft moves from the shaft hole of the second support shaft toward the opening for preventing rearward movement through the movement allowing part. Since the intermediate lever is connected to the operation pedal via the coupling link, the operation pedal forcibly pivots following the movement of the second support shaft. That is, the depressing part of the operation pedal is prevented from displacing toward the vehicle rear side without displacing the output member toward the vehicle front side.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A rearward movement preventing device of a pedal device for vehicle, the pedal device for vehicle comprising:
a pedal bracket configured to fix to a dash panel on a vehicle front side and include a pair of side plates arranged with a gap in a vehicle width direction;
an operation pedal configured to pivotally support by a first support shaft arranged in the pair of side plates of the pedal bracket and include a depressing part used for depressing operation toward the vehicle front side;
an intermediate lever configured to pivotally support around a second support shaft arranged in parallel with the first support shaft with respect to the pedal bracket, the intermediate lever pivots around the second support shaft toward an output direction to displace a prescribed output member toward the vehicle front side; and
a coupling link configured to connect the operation pedal to the intermediate lever and pivot the intermediate lever toward the output direction in conjunction with the depressing operation of the operation pedal; wherein
the rearward movement preventing device prevents the depressing part of the operation pedal from displacing toward a vehicle rear side when the dash panel is displaced toward the vehicle rear side, and wherein
the pair of side plate of the pedal bracket includes:
an opening for preventing rearward movement configured to be in a direction of a load acting on the second support shaft at a time of vehicle collision with respect to a shaft hole of the second support shaft; and
a movement allowing part configured to hold the second support shaft into the shaft hole of the second support shaft and allow movement of the second support shaft toward the opening for preventing rearward movement when the load due to the vehicle collision acts.

2. The rearward movement preventing device of the pedal device for vehicle according to claim 1, wherein
the movement allowing part includes:
a protrusion part configured to protrude from an opening edge of the shaft hole of the second support shaft on a side opposite to a side where a load acts on the second support shaft and hold the second support shaft into the shaft hole in the depressing operation of the operation pedal; and
a cutout part configured to form on a base end of the protrusion part.

3. The rearward movement preventing device of the pedal device for vehicle according to claim 2, wherein
the protrusion part is provided so that an angle formed by placing the opening for preventing rearward movement between a direction of the load acting on the second support shaft in the depressing operation of the operation pedal and a straight line connecting the second support shaft held into the shaft hole to a tip of the protrusion part is set to 90 degrees or more.

4. The rearward movement preventing device of the pedal device for vehicle according to claim 1, further comprising a cylindrical member configured to insert by the second support shaft and arrange to the shaft hole of the second support shaft, wherein
the cylindrical member includes:
a cylindrical part arranged between an outer periphery of the second support shaft and an opening edge of the shaft hole of the second support shaft; and
a flange part configured to extend from the cylindrical part toward an outside in a radial direction and arrange along the side plate.

5. The rearward movement preventing device of the pedal device for vehicle according to claim 1, further comprising a projecting edge part configured to protrude on a side where a load acts on the second support shaft in the depressing operation of the operation pedal in a boundary position continuously provided with the shaft hole and the opening for preventing rearward movement, the projecting edge part provided with a slope located higher from the shaft hole toward the opening for preventing rearward movement, wherein
the slope of the projecting edge part inclines by 90 degrees or more with respect to a direction of the load acting on the second support shaft in the depressing operation of the operation pedal.

6. The rearward movement preventing device of the pedal device for vehicle according to claim 1, further comprising a third support shaft configured to pivotally support the intermediate lever with respect to the output member, wherein
the opening for preventing rearward movement is located in a direction of a tangent in the second support shaft held into the shaft hole on a circumference configured to define a distance between the second support shaft and the third support shaft as a radius and the third support shaft as a center.

7. The rearward movement preventing device of the pedal device for vehicle according to claim 1, wherein
the second support shaft is arranged on the vehicle rear side relative to the first support shaft in the pair of side plate of the pedal bracket, and wherein
the opening for preventing rearward movement and the movement allowing part are formed on the vehicle rear side relative to the shaft hole of the second support shaft.

8. The rearward movement preventing device of the pedal device for vehicle according to claim 1, wherein
the second support shaft is arranged on the vehicle front side relative to the first support shaft in the pair of side plate of the pedal bracket, and wherein
the opening for preventing rearward movement and the movement allowing part are formed on the vehicle front side relative to the shaft hole of the second support shaft.
